(19) United States
(12) Patent Application Publication
(10) Pub. No.: US 2008/0213593 A1
(43) Pub. Date: Sep. 4, 2008

(54) Systems And Methods For Forming Fluidic Droplets Encapsulated In Particles Such As Colloidal Particles

(75) Inventors: Anand Bala Subramaniam, Cambridge, MA (US); Manouk Abkarian, Somerville, MA (US); Howard A. Stone, Brookline, MA (US)

Correspondence Address: WOLF GREENFIELD & SACKS, P.C., 600 ATLANTIC AVENUE, BOSTON, MA, 02210-2206, US

(73) Assignee: President and Fellows of Harvard College, Cambridge, MA (US)

(21) Appl. No.: 11/794,940

(22) PCT Filed: Jan. 20, 2006
(86) PCT No.: PCT/US06/01938

§ 371 Date: Apr. 21, 2008

Related U.S. Application Data
(60) Provisional application No. 60/646,585, filed on Jan. 21, 2005.
(60) Provisional application No. 60/674,812, filed on Apr. 26, 2005.

(51) Int. Cl. B32B 5/16; B01J 13/02

(52) U.S. Cl. 428/402.2; 264/4.1

(57) ABSTRACT

The present invention generally relates to systems and methods for forming fluidic droplets comprising particles such as colloidal particles, which may be distributed on the surfaces of the fluidic droplets in some cases, thereby encapsulating the fluidic droplets. The particles at least partially surrounding the fluidic droplet may be colloidal particles in some cases, i.e., forming a “colloidal capsule.” In one set of embodiments, the particles may be positioned on the surface of a fluidic droplet such that the fluidic droplet is able to maintain a shape that, when left undisturbed, is not achievable by an undisturbed fluidic droplet free of discrete particles, for example, elongated or prolate ellipsoid fluidic droplets. Such fluidic droplets may also exhibit unusual properties, for example, plasticity, isolation from electromagnetic fields, certain electrical and/or magnetic properties, and/or mechanical resistance. In certain embodiments, multiple fluidic droplets may be prevented from fusing or coalescing into one droplet when coming into physical contact, due to the presence of particles on the fluidic droplets. However, the fluidic droplets may be induced into fusing or coalescing by initially deforming one or more of the fluidic droplets, e.g., mechanically.

### RELATED APPLICATIONS

This application claims the benefit of U.S. Provisional Patent Application Ser. No. 60/646,585, filed Jan. 21, 2005, entitled “Systems and Methods for Forming Fluidic Droplets,” by Stone, et al.; and the benefit of U.S. Provisional Patent Application Ser. No. 60/674,812, filed Apr. 26, 2005, entitled “Systems and Methods for Forming Fluidic Droplets Encapsulated in Particles such as Colloidal Particles,” by Stone, et al., each of which is incorporated herein by reference.

### FIELD OF INVENTION

The present invention generally relates to systems and methods for forming fluidic droplets and, in particular, to systems and methods for forming fluidic droplets comprising particles such as colloidal particles, which may be distributed on the surfaces of the fluidic droplets in some cases, thereby encapsulating the fluidic droplets.

### BACKGROUND

Colloidal particles adsorbed on liquid interfaces have been reported to stabilize emulsions and foams. Individual droplets densely covered with small particles have been suggested as a possible means of obtaining a variety of composite particles and hollow locked shells. Such interfacially structured and protected materials could potentially offer new opportunities in many fields, for example, in optics, encapsulation, biomedicine, non-wetting droplets, stabilizing gas bubbles, mineral flotation, or foods. However, such particle shells vary widely in size, quality, and stability. Furthermore, additional chemical or thermal locking steps have to be performed for stability.

### SUMMARY OF THE INVENTION

The present invention generally relates to systems and methods for forming fluidic droplets comprising particles such as colloidal particles, which may be distributed on the surfaces of the fluidic droplets in some cases, thereby encapsulating the fluidic droplets. The subject matter of the present invention involves, in some cases, interrelated products, alternative solutions to a particular problem, and/or a plurality of different uses of one or more systems and/or articles.

In one aspect, the present invention provides an article. The article, according to one set of embodiments, includes a fluidic droplet, encapsulated with discrete particles, able to retain a shape when left undisturbed that is not achievable by an undisturbed fluidic droplet free of discrete particles.

In certain aspects, the present invention is a method. According to one set of embodiments, the method includes an act of growing a fluidic droplet encapsulated with discrete particles by supplying the particles to a fluid-fluid interface. In another set of embodiments, the method includes acts of providing a fluidic droplet able to retain a shape when left undisturbed that is not achievable by an undisturbed fluidic droplet free of discrete particles, and causing the fluidic droplet to form a shape achievable by an undisturbed fluidic droplet free of discrete particles. The method, in still another set of embodiments, includes acts of mechanically deforming a first fluidic droplet, and fusing the first fluidic droplet to a second fluidic droplet. In some cases, the first fluidic droplet and the second fluidic droplet are not able to fuse without initially deforming at least the first fluidic droplet. In yet another set of embodiments, the method includes an act of shaping a layer of discrete particles disposed between a gas and a liquid to produce one or more fluidic droplets encapsulated with the particles. In still another set of embodiments, the method includes an act of administering, to a subject, a composition comprising a fluidic droplet encapsulated with discrete particles.

In yet another aspect, the present invention is directed to a composition. In one set of embodiments, the composition includes a fluidic droplet encapsulated with discrete particles, in combination with a pharmaceutically acceptable carrier.

In another aspect, the present invention is directed to a method of making one or more of the embodiments described herein, for example, fluidic droplets comprising particles. In yet another aspect, the present invention is directed to a method of using one or more of the embodiments described herein, for example, fluidic droplets comprising particles.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1H illustrate the production of certain encapsulated fluidic droplets of the invention;

FIGS. 2A-2E illustrate the fusion of certain encapsulated fluidic droplets, in another embodiment of the invention;

FIGS. 3A-3H illustrate the deformation of encapsulated fluidic droplets, in accordance with yet another embodiment of the invention;

FIGS. 4A-4C illustrate the release of particles from an encapsulated fluidic droplet, according to still another embodiment of the invention;

FIG. 5 is a schematic illustration of a microfluidic device useful in certain embodiments of the invention;

FIG. 6 is a schematic cross-sectional view through line 6-6 of FIG. 5;

FIGS. 7A-7D illustrate various encapsulated fluidic droplets according to another embodiment of the invention;

FIGS. 8A-8B illustrate the formation of fluidic droplets having a heterogeneous distribution of particles on their surfaces, in accordance with another embodiment of the invention;

FIG. 9 illustrates another method of forming a fluidic droplet having a heterogeneous distribution of particles on its surface, according to another embodiment of the invention;

FIGS. 10A-10C are various photomicrographs illustrating fluidic droplets having a heterogeneous distribution of particles on their surfaces, in another embodiment of the invention;

FIG. 11 illustrates a flow focusing device, useful in certain embodiments of the invention;

FIGS. 12A-12D illustrate various encapsulated fluidic droplets, in other embodiments of the invention;

FIG. 13 illustrates a fluidic droplet encapsulated with a colloidal particle shell, in yet another embodiment of the invention;

FIGS. 14A-14C illustrate certain encapsulated fluidic droplets compressed between plates, in accordance with another embodiment of the invention;

FIGS. 15A-15E illustrate continuous fluidic droplet formation, in another embodiment of the invention;

FIGS. 16A-16D illustrate a time-lapse sequence of fluidic droplet formation, according to yet another embodiment of the invention;

FIGS. 17A-17B illustrate the packing of particles on a fluidic droplet, in another embodiment of the invention;

FIGS. 18A-18B are photomicrographs of particles on a mineral fluidic droplet, according to another embodiment of the invention;

FIGS. 19A-19B are photomicrographs of fluidic droplets having more than one type of particle on their surfaces, in accordance with yet another embodiment of the invention;

FIGS. 20A-20D are schematic diagrams of a method of forming fluidic droplets, in accordance with one embodiment of the invention;

FIGS. 21A-21E are photomicrographs of various encapsulated fluidic droplets of the invention;

FIGS. 22A-22D illustrate several toroidal bubbles, produced according to still another embodiment of the invention;

FIGS. 23A-23E are photomicrographs of a cylindrical encapsulated fluidic droplets, produced in accordance with yet another embodiment of the invention;

FIGS. 24A-24D illustrate fluidic droplets having a generally flat facet, in still another embodiment of the invention;

FIGS. 25A-25F illustrate fluidic droplets exposed to a surfactant at a concentration greater than CMC, in one embodiment of the invention;

FIGS. 26A-26F illustrate fluidic droplets exposed to a surfactant at a concentration less than CMC, in another embodiment of the invention;

FIG. 27 is a diagram illustrating the response to a surfactant of yet another embodiment of the invention; and

FIGS. 28A-28E illustrate fluidic droplets exposed to another surfactant, in accordance with still another embodiment of the invention.

### DETAILED DESCRIPTION

The present invention generally relates to systems and methods for forming fluidic droplets comprising particles such as colloidal particles, which may be distributed on the surfaces of the fluidic droplets in some cases, thereby encapsulating the fluidic droplets. The particles at least partially surrounding the fluidic droplet may be colloidal particles in some cases, i.e., forming a “colloidal capsule.” In one set of embodiments, the particles may be positioned on the surface of a fluidic droplet such that the fluidic droplet is able to maintain a shape that, when left undisturbed, is not achievable by an undisturbed fluidic droplet free of discrete particles, for example, elongated or prolate ellipsoid fluidic droplets. Such fluidic droplets may also exhibit unusual properties, for example, plasticity, isolation from electromagnetic fields, certain electrical and/or magnetic properties, and/or mechanical resistance. In certain embodiments, multiple fluidic droplets may be prevented from fusing or coalescing into one droplet when coming into physical contact, due to the presence of particles on the fluidic droplets. However, the fluidic droplets may be induced into fusing or coalescing by initially deforming one or more of the fluidic droplets, e.g., mechanically.

The following documents are incorporated herein by reference: U.S. Provisional Patent Application Ser. No. 60/498,091, filed Aug. 27, 2003, by Link, et. al.; U.S. Provisional Patent Application Ser. No. 60/392,195, filed Jun. 28, 2002, by Stone, et. al.; U.S. Provisional Patent Application Ser. No. 60/424,042, filed Nov. 5, 2002, by Link, et al.; U.S. Pat. No. 5,512,131, issued Apr. 30, 1996 to Kumar, et al.; International Patent Publication WO 96/29629, published Jun. 26, 1996 by Whitesides, et al.; U.S. Pat. No. 6,355,198, issued Mar. 12, 2002 to Kim, et al.; International Patent Application Serial No.: PCT/US01/16973, filed May 25, 2001 by Anderson, et al., published as WO 01/89787 on Nov. 29, 2001; International Patent Application Serial No. PCT/US03/20542, filed Jun. 30, 2003 by Stone, et al., published as WO 2004/002627 on Jan. 8, 2004; International Patent Application Serial No. PCT/US2004/010903, filed Apr. 9, 2004 by Link, et al.; U.S. Provisional Patent Application Ser. No. 60/461,954, filed Apr. 10, 2003, by Link, et al.; and International Patent Application Serial No. PCT/US2004/027912, filed Aug. 27, 2004 by Link, et al. Also incorporated herein by reference are U.S. Provisional Patent Application Ser. No. 60/646,585, filed Jan. 21, 2005, entitled “Systems and Methods for Forming Fluidic Droplets,” by Stone, et al., and U.S. Provisional Patent Application Ser. No. 60/674,812, filed Apr. 26, 2005, entitled “Systems and Methods for Forming Fluidic Droplets Encapsulated in Particles such as Colloidal Particles,” by Stone, et al.

In one aspect, a plurality of particles may be present on the surface of the fluidic droplet, surrounding or at least partially surrounding the fluidic droplet. For example, at least about 50%, at least about 60%, at least about 70%, at least about 80%, at least about 85%, at least about 90%, or at least about 95% of the surface of the fluidic droplet may be surrounded by one or more types of particles. A “fluidic droplet,” as used herein, is an isolated portion of a first fluid that is completely surrounded by a second fluid. As used herein, a first fluid is “surrounded” by a second fluid if a closed planar loop can be theoretically drawn around the first fluid through only the second fluid. A first fluid is “completely surrounded” if closed loops going through only the second fluid can be drawn around the first fluid regardless of direction (orientation of the loop). Thus, a fluidic droplet may be completely surrounded by a liquid (the second fluid), for example, as in a suspension or an emulsion, etc.

Any fluid may be present within the fluidic droplet, for example, a liquid or a gas. As used herein, the term “fluid” generally refers to a substance that tends to flow and to conform to the outline of its container, i.e., a liquid or a gas, etc. Typically, fluids are materials that are unable to withstand a static shear stress, and when a shear stress is applied to the material in isolation, the fluid experiences a continuing and permanent distortion, e.g., the fluid is able to flow. The fluid may have any suitable viscosity that permits such distortion or flow. Non-limiting examples of gases include air, O₂, H₂, CO, noble gases, etc. Examples of liquids include, but are not limited to, hydrophilic liquids such as water or other aqueous solutions comprising water, for example salt solutions, etc., as well as other hydrophilic liquids such as ethanol; or hydrophobic liquids, for example, oils such as hydrocarbons, silicone oils, mineral oils, fluorocarbon oils, organic solvents etc. The surrounding or “continuous” fluid surrounding the fluidic droplet may be a liquid, for example, water. In some, but not all, embodiments, the surrounding fluid and the fluid within the fluidic droplet are essentially immiscible, i.e., the fluids are immiscible on a time scale of interest.

In certain embodiments, the fluidic droplets may contain additional entities besides the above-described particles or entities, for example, other chemical, biochemical, or biological entities (e.g., dissolved or suspended in the fluid within the fluidic droplet), cells, other particles, gases, molecules, or the like. For example, the fluidic droplet may include one or more particles (including colloidal capsules, encapsulated fluidic droplets, or other fluidic droplets comprising particles, as described herein), biological cells, solids such as crystals, etc. Non-limiting examples include those disclosed in International Patent Application Serial No. PCT/US2004/027912, filed Aug. 27, 2004 by Link, et al., incorporated herein by reference. Thus, for example, the fluidic droplets containing the particles may be used to encapsulate drugs, flavors, other chemicals, etc. For instance, a fluidic droplet (e.g., a microfluidic droplet) containing the particles may contain an active chemical compound, e.g., as a gas or a liquid, and used in applications such as health care, foods, or medical applications. As an example, such fluidic droplets may be used as ultrasound diagnostic or contrast agents. In another set of embodiments, certain fluidic droplets of the invention may be used for froth flotation, where air or other gases is bubbled through a suspension containing certain minerals, and with the recognition that added energy, such as stirring, may enhance the collection efficiency, the froth with the desired minerals is collected. By targeting minerals to the fluidic droplets (e.g., containing air or other gases), the yield of such a process may be increased. In another embodiment, one or more particles surrounding the fluidic droplet may contain a drug, flavor, chemical, etc.

In certain embodiments, the fluidic droplet is a microfluidic droplet, i.e., a droplet having at least one dimension less than about 1 mm, and in some embodiments, at least one dimension that is less than about 500 microns, less than about 300 microns, less than about 200 microns, less than about 100 microns, less than about 50 microns, less than about 30 microns, less than about 20 microns, or less than about 10 microns. In certain instances, the fluidic droplet may have a smallest dimension that is greater than about 50 microns, greater than about 10 microns, greater than about 20 microns, greater than about 30 microns, greater than about 50 microns, greater than about 100 microns, greater than about 200 microns, greater than about 300 microns, or greater than about 500 microns. The maximum dimension of the fluidic droplet, in some instances, may also be at least about 1 micrometer, at least about 2 micrometers, at least about 3 micrometers, at least about 5 micrometers, at least about 10 micrometers, at least about 15 micrometers, or at least about 20 micrometers.

In certain cases, the fluidic droplet, which may be spherical or non-spherical, may have an average diameter less than about 1 mm. As used herein, the “average diameter” of a non-spherical droplet, is the mathematically-defined average diameter of the droplet, integrated across the entire surface of the droplet. In certain embodiments, the average diameter of the fluidic droplet may also be less than about 500 micrometers, less than about 300 micrometers, less than about 200 micrometers, less than about 100 micrometers, less than about 50 micrometers, less than about 30 micrometers, less than about 20 micrometers, or less than about 10 micrometers in some cases. The average diameter of the fluidic droplet, in some embodiments, may also be at least about 1 micrometer, at least about 2 micrometers, at least about 3 micrometers, at least about 5 micrometers, at least about 10 micrometers, at least about 15 micrometers, or at least about 20 micrometers.

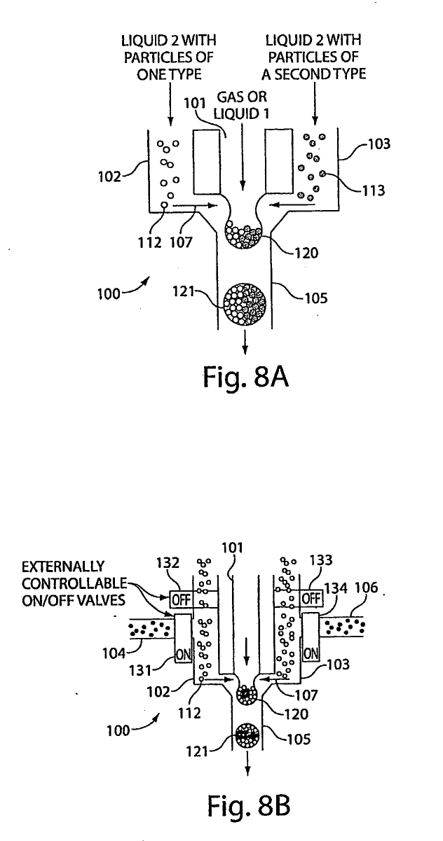

Various embodiments of the invention will have a plurality of particles present on the surface of the fluidic droplet, encapsulating or surrounding, or at least partially surrounding, the fluidic droplet. The particles may be all the same, or different particles may be present (for example, the particles may differ with respect to composition, size, diameter, shape, density, porosity, hydrophilicity, etc.). Some or all of the particles may be colloidal, in some cases. Typically, the particles are smaller than the fluidic droplet. For example, some or all of the particles may have a maximum dimension of less than about 10 microns, less than about 7 microns, less than about 5 microns, less than about 4 microns, less than about 2 microns, less than about 1 micron, less than about 500 nm, less than about 300 nm, less than about 200 nm, less than about 100 nm, less than about 50 nm, less than about 30 nm, less than about 20 nm, or less than about 10 nm. The particles are not thermally treated (e.g., sintering) or chemically reacted in some embodiments of the invention, e.g., such that the particles are bonded together, and thus, the particles remain discreet. However, in other embodiments of the invention, the particles are sintered or locked together in some fashion, for example, through chemical reactions, thermal processes, or the like. If more than one type of particle is present, the different types of particles may be homogeneously distributed, or heterogeneously distributed in some cases. For instance, as is shown in FIGS. 8-10, the different types of particles may be distributed in bands or layers within each fluidic droplet. In some cases, the fluidic droplets may also contain particles within their interiors (i.e., such that the particles are not in direct contact with the surface of the fluidic droplet); such particles may be the same as, or different from, the particles present on the surface.

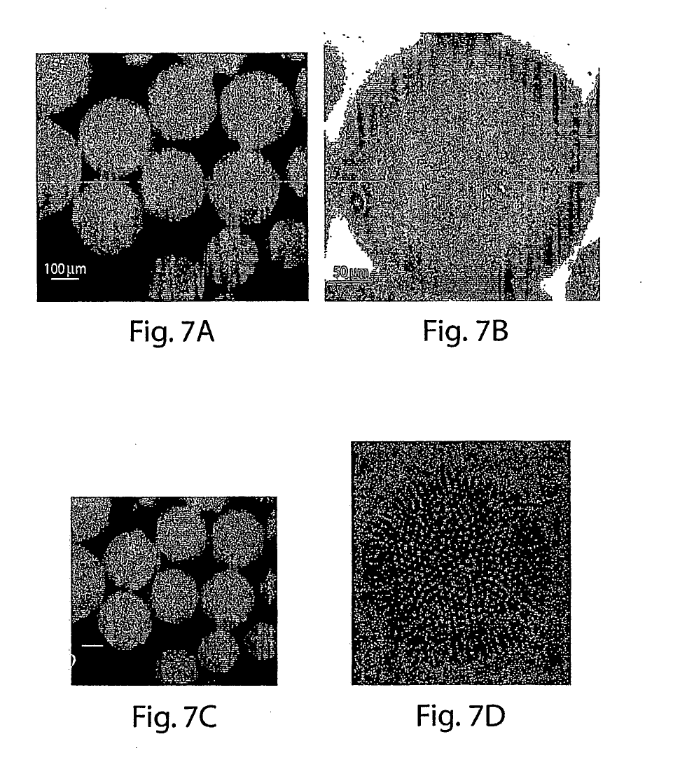

The particles may have any suitable composition that is compatible with the fluidic droplet. For example, the particles may have a composition chosen such that the particles can be tightly packed onto the surface of the fluidic droplet, as further discussed below. The ability of the particles to be tightly packed on onto the surface of the fluidic droplet may also be independent of the nature of particle-particle interactions in certain cases (for example, the fluidic droplet may contain particles that are charged and/or uncharged, hydrophobic and/or hydrophilic, etc.); thus, a wide variety of particle compositions may be chosen, depending on the particular application. For example, the particles may comprise one or more metals (e.g., gold, silver, titanium, etc.) and/or one or more non-metals, for instance, one or more polymers (e.g., polystyrene, polymethylmethacrylate, etc.), one or more metal oxides such as silica, titania, or the like, etc. In some cases, the particles may be biodegradable and/or biocompatible. Non-limiting examples of such particles are illustrated in FIG. 7C (gold particles on a gas bubble) and FIG. 7D (silica particles on an oil droplet; some scattering of light results from differences in the optical indexes of silica, oil, and water). As another example, the particle may comprise one or more biodegradable polymers, for example, polylactide, polyglycolide, polyvinyl alcohol, or the like. Copolymers of these and/or polymers are also envisioned in certain embodiments. In one embodiment, at least a portion of the particles are fluorescent. In some cases, at least a portion of the particles are hydrophobic, i.e., having a generally low affinity to water. At least a portion of the particles may also be hydrophilic in certain instances, i.e., having a generally high affinity to water. The particles may have any other desired physical property, for example, electrical properties, magnetic properties, etc. For instance, at least a portion of the particles may be electrically conductive (i.e., having a generally high electrical conductivity), electrically isolative (i.e., having a generally low electrical conductivity), magnetic, paramagnetic, or the like. In some embodiments, of course, particles having more than one type of property may be used, and/or more than type of particle, having different properties, may be used. For example, a fluidic droplet may comprise particles that are both magnetic and hydrophilic, particles that are both magnetic and hydrophobic, particles that are hydrophobic and particles that are hydrophilic, metallic particles and non-metallic particles, etc.

For instance, in one embodiment, at least a portion of the particles encapsulating the fluidic droplet are electrically conductive, and the encapsulation of the fluidic droplet by the conductive particles may create a “Faraday cage” effect around the fluidic droplet, or at least a portion of it. Such a Faraday cage effect may prevent, or at least attenuate, electric fields that are applied externally to the fluidic droplet from reaching the interior of the fluidic droplet.

As another example, the properties of the particles and/or the fluidic droplet may be chosen to facilitate separation processes. For instance, the fluidic droplet and/or the particles may have a density that is substantially greater or lesser than a surrounding fluid, allowing separation of the fluidic droplet to occur through differences in density. As another example, the fluidic droplet and/or the particles may be magnetic and/or contain a magnetic entity, such that the fluidic droplets can be separated using a magnetic field. As yet another example, the fluidic droplet and/or the particles may be fluorescent and/or contain a fluorescent entity, such that the fluidic droplets can be separated on the basis of their fluorescence.

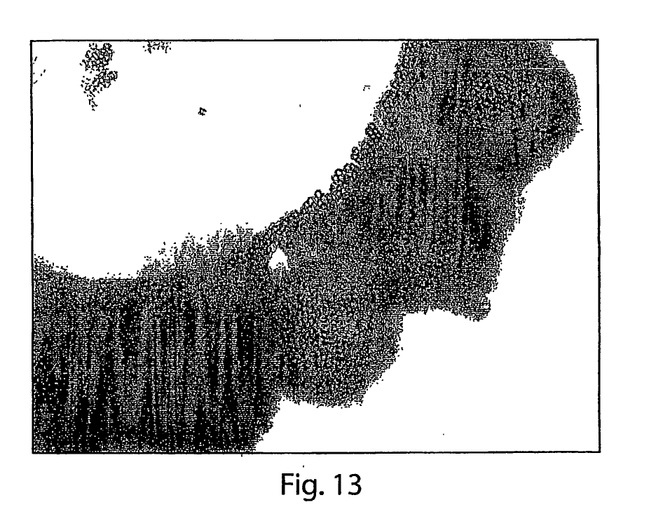

According to certain embodiments of the invention, the particles are tightly packed onto the surface of the fluidic droplet, there by producing a particle shell that encapsulates or surrounds the fluidic droplet. For example, the particles may be packed onto the surface such that most or all of the particles are in physical contact with at least one, two, three, four, five, or six other particles (e.g., “hexagonal packing”). In some cases, the particles may be packed onto the surface of the fluidic droplet at a density such that there are no contiguous exposed areas of the surface of the fluidic droplet large enough to add another comparable particle to. The particles packed on the surface of the fluidic droplet may be said to have “encapsulated” the fluidic droplet, creating a particle “shell” or “armor.” Such packing, in some cases, may prevent any detectable Brownian motion of the particles on the surface of the fluidic droplet from occurring. In some cases, even higher numbers of particles may be added to the fluidic droplet. For example, the droplet may be encapsulated in more than one layer of particles, e.g., as is shown in FIG. 13. In some cases, enough particles are present on the surface of the fluidic droplet such that the particles are able to fill in any gaps created in the particle shell (e.g., created artificially or externally). In certain embodiments, the combined volume of the particles on the fluidic droplet is greater than about 0.5%, 0.7%, 1%, 1.3%, 1.5%, 2%, or 5% of the volume of the fluidic droplet. In some embodiments, however, the combined volume of the particles added to the fluidic droplet is less than about 10%, 7%, or 5% of the volume of the fluidic droplet.

The “shell” or “armor” of particles encapsulating the fluidic droplet may allow the fluidic droplet to retain a shape when left undisturbed that is not achievable by an undisturbed fluidic droplet free of discrete particles. Without wishing to be bound to any theory, it is believed that the high particle interfacial densities causes “jamming” of the particles, such that the fluidic droplet is unable to alter its shape spontaneously; alterations in shape require additional energy to create new fluid-fluid interfaces with the fluidic droplet and the surrounding fluid. The “jamming” behavior of the particles can occur even if the particles remain discrete, e.g., the particles on the surface of the fluidic droplet are not chemically reacted or thermally fused together. Additionally, a fluidic droplet encapsulated in such a fashion may be unable to fuse or coalesce with other fluidic droplets in some cases (the other fluidic droplets may also be encapsulated in some cases), even if the fluidic droplets are in direct, physical contact with each other.

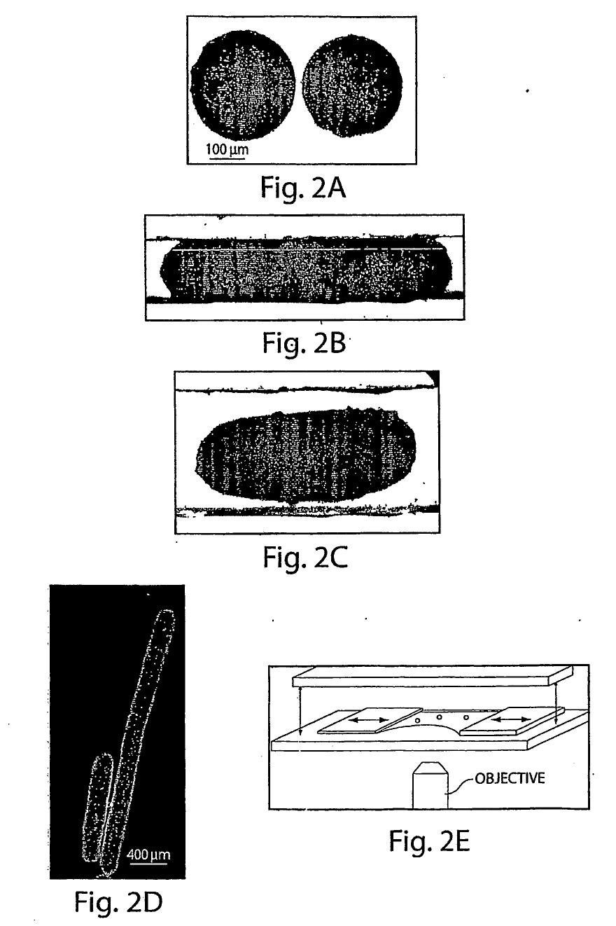

If energy is applied to the fluidic droplet (for example, mechanical energy or thermal energy), the fluidic droplet may be deformed, for example, exposing new regions of its surface that are generally free of particles to the surrounding or “continuous” fluid. Such new regions may participate in, for example, fusion with other fluidic droplets, thereby allowing coalescence of the fluidic droplets to occur. As a specific example, a fluidic droplet may be deformed mechanically by pressing the fluidic droplet between two surfaces, for example, two glass or metal surfaces, e.g., as is shown in FIG. 2B. Such deformations of the fluidic droplet may exhibit plasticity behavior, i.e., the fluidic droplet may be fairly extensively deformed non-elastically, without rupture or breakage of the fluidic droplet. In some cases, new kinds of colloidal capsules or other encapsulated fluidic droplets may be created using such fusion techniques. For instance, two or more colloidal capsules or other fluidic droplets may be fused together, where the particles within each of the droplets may the same or different, to create new colloidal capsules or other encapsulated fluidic droplets.

Thus, another aspect of the invention generally relates to fluidic droplets that are able to retain their shape when left undisturbed, where such shapes are generally non-equilibrium shapes, i.e., shapes that unmodified fluidic droplets cannot retain at equilibrium. For instance, while a normal fluidic droplet, when left undisturbed in solution or suspension for a time sufficient to allow the fluidic droplet to reach equilibrium, will generally have a generally spherical shape, the fluidic droplets of the invention may have elongated (e.g., “cigar-like”), prolate, cylindrical, toroidal, distorted, bent, or other non-spherical shapes when left undisturbed. In certain embodiments, a plurality of particles may be present and can be closely packed on the surface of the fluidic droplet, where such particles allow the fluidic droplet to exhibit such behavior.

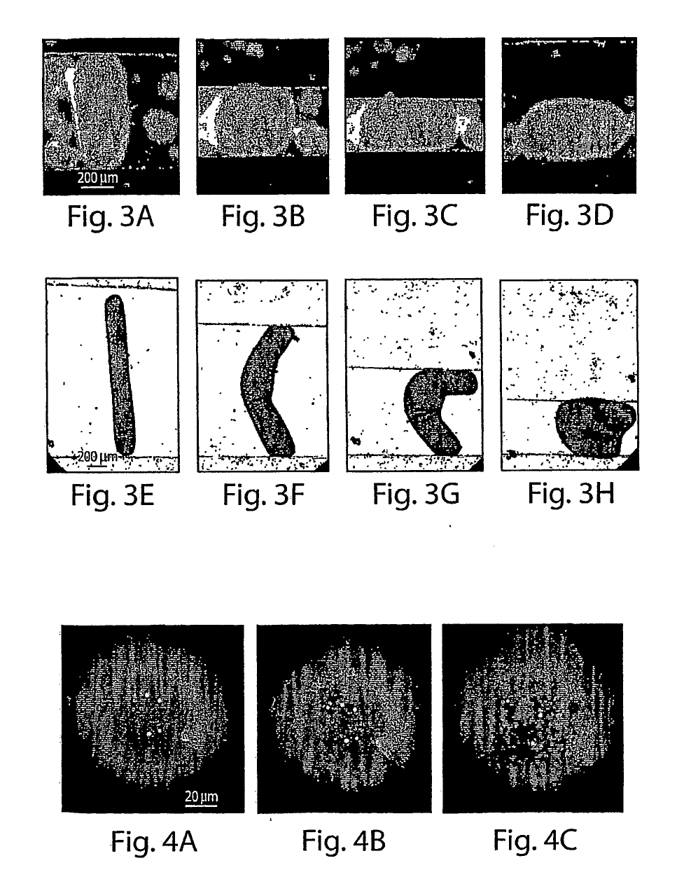

As used herein, a “non-spherical” droplet is a droplet having dimensions such that, when imaged (for example, using light or electron microscopy), the droplet can be characterized as being visibly non-spherical. Examples of non-spherical droplets include, but are not limited to, rods, discs, cylinders, toroids, ellipsoids such as prolate ellipsoids and oblate ellipsoids, elongated droplets (e.g., “cigar-shaped” droplets), which may be straight (e.g., FIG. 2D), or “bent” in some cases (i.e., the major axis of the droplet is not a straight line, see e.g., FIG. 3F), or the like. In some embodiments, the non-spherical droplet may have an aspect ratio (ratio of the largest dimension of the droplet that passes through the center of the droplet, with respect to the smallest dimension of the droplet that passes through the center of the droplet) of at least about 1.3:1, and in certain instances, the aspect ratio may be at least about 1.5:1, at least about 2:1, at least about 3:1, at least about 4:1, at least about 5:1, at least about 7:1, at least about 10:1, at least about 12:1, at least about 15:1, at least about 20:1, or more in some cases.

In some cases, the fluidic droplets comprising particles (for example, a colloidal capsule) may be “refluidized,” i.e., treated such that the fluidic droplets are no longer able to retain a shape when left undisturbed that is not achievable by an undisturbed fluidic droplet free of discrete particles. A fluidic droplet may be refluidized, in one set of embodiments, by exposing the fluidic droplet to an agent able to decrease the interfacial surface energy of the particles, i.e., such that less additional energy (e.g., below thermal ambient energy) is needed to create new fluid-fluid interfaces with the fluidic droplet and the surrounding fluid. For example, in one embodiment, a fluidic droplet is refluidized by exposing the fluidic droplet to a surfactant, such as octyl phenol ethoxylate or Triton® X. Other surfactants include, but are not limited to, sodium dodecyl sulfate, other ethoxylates, alkoxylates, glucosides, sulfates, sulfonates, disulfonates, phosphate esters, sulfosuccinates, or certain quaternary ammonium salts. In some cases, a surfactant may be applied to the fluidic droplets to cause release of the particles from the fluidic droplet (and/or release of the fluid droplet from the particles). For example, if the fluidic droplet and/or the particles surrounding the fluidic droplet contains a drug, flavor, chemical, etc., the addition of a surfactant may cause the release of the particles from the fluidic droplet, which may be used to facilitate delivery of the particles, e.g., as a controlled release technology.

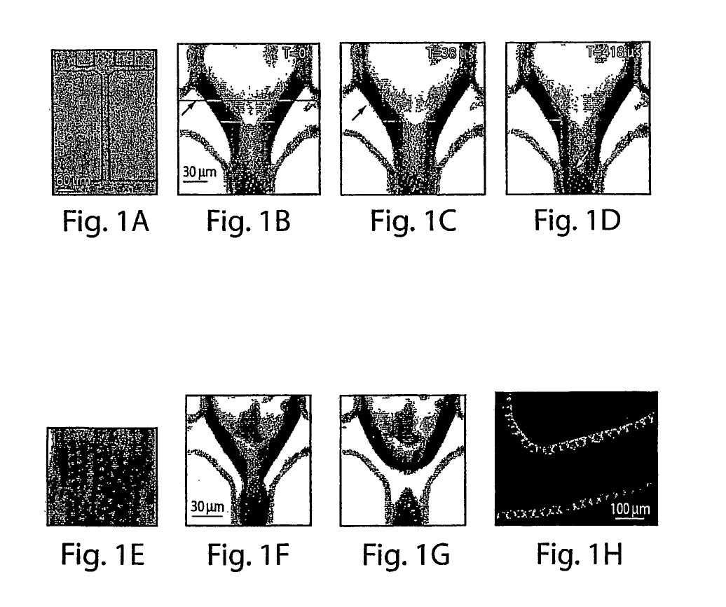

The above-described fluidic droplets comprising particles can be prepared, according to another aspect of the invention, by targeting one or more types of particles at a fluid-fluid interface, where the fluid-fluid interface is used for generating a fluidic droplet (i.e., the first fluid forms the fluidic droplet, while the second fluid is the continuous fluid surrounding the fluidic droplet). Those of ordinary skill in the art will be aware of methods of directing a particle at a generally fluid/fluid interface. For example, one or more channels, such as microfluidic channels, may be used to direct particles and/or a fluid containing the particles at the fluidic droplet. The selection of particles and/or fluids (e.g., non-compatible or essentially immiscible fluids) may be used to assist in the formation of the fluidic droplets containing particles, etc., in connection with the present invention. For example, fluidic droplets contained within a liquid may be exposed to a hydrodynamic flow (of a given velocity) of a suspension of particles to encapsulate the fluidic droplets with the particles. For instance, the fluidic droplets may be exposed to the particle suspension through the use of shear stresses. In some embodiments, glass plates may be used to apply the necessary shear stresses, and in other embodiments, vortexing or other mixing techniques may be used. Another non-limiting example is illustrated in FIG. 1A for an air/water interface, where air droplets or “bubbles” are produced in water. In one set of embodiments, a microfluidic device is used to produce the particles, for example, as disclosed in International Patent Application Serial No. PCT/US03/20542, filed Jun. 30, 2003 by Stone, et al., published as WO 2004/002627 on Jan. 8, 2004; or International Patent Application Serial No. PCT/US2004/027912, filed Aug. 27, 2004 by Link, et al.; each incorporated herein by reference.

In certain embodiments, a hydrodynamic focusing apparatus is used to direct one or more types of particles at the fluid-fluid interface to produce the fluidic droplets. A hydrodynamic focusing apparatus allows the formation of fluidic droplets within a surrounding fluid, of controlled size and size distribution, in a flow system (e.g., a microfluidic system) free of moving parts to create droplet formation. That is, at the location or locations at which the fluidic droplets are formed, the device is free of components that move relative to the device as a whole to affect droplet formation or size. For example, where fluidic droplets of controlled size are formed, they are formed without parts that move relative to other parts of the device that define a channel within the drops flow. Thus, in one set of embodiments, by directing hydrodynamic energy to the particles using such an apparatus, the particles may be caused to form a particle shell surrounding or at least partially surrounding a fluidic droplet. As used herein, in this context, “hydrodynamic energy” is the energy (i.e., kinetic energy) from the flow of fluid that allows the particles to come into contact with the fluidic droplet and, assisted by such energy, form a particle shell surrounding or at least partially surrounding a fluidic droplet, and a “hydrodynamic focusing apparatus” is an apparatus that is configured and arranged to allow hydrodynamic energy to be used to direct particles into contact with a fluidic droplet.

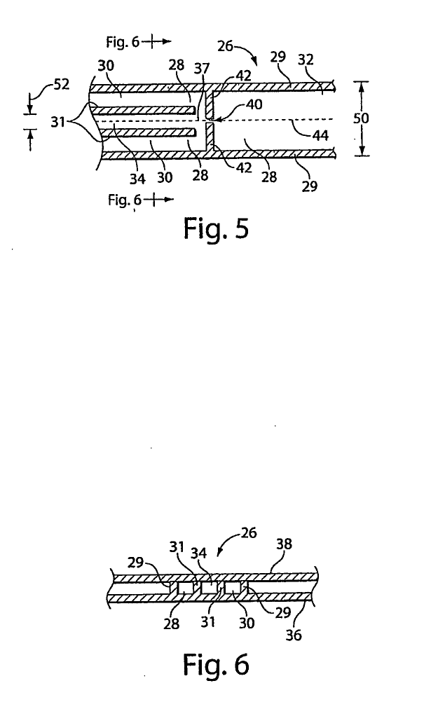

Referring now to FIG. 5, one embodiment of the present invention, in the form of a microfluidic system 26, is illustrated schematically in cross-section (although it will be understood that a top view of system 26, absent top wall 38 of FIG. 6, would appear similar). Although “top” and “bottom” are used to define certain portions and perspectives of systems of the invention, it is to be understood that the systems can be used in orientations different from those described. For reference, it is noted that the system is designed such that fluid flows optimally from left to right per the orientation of FIG. 5. System 26 includes a series of walls defining regions of the microfluidic system via which the system will be described. A microfluidic interconnected region 28 is defined in the system by walls 29, and includes an upstream portion 30 and a downstream portion 32, connected to an outlet further downstream which is not shown in FIG. 5. In the embodiment illustrated in FIG. 5, a fluid channel 34, defined by side walls 31, is provided within the outer boundaries of interconnected region 28. Fluid channel 34 has an outlet 37 between upstream portion 30 and downstream portion 32 of interconnected region 28. The system is thus arranged to deliver a fluid (which will form the fluidic droplet) from channel 34 into the interconnected region between the upstream portion and the downstream portion.

FIG. 6 is a cross-sectional illustration through line 6-6 of FIG. 5. This figure shows (in addition to some of the components shown in FIG. 5, e.g., walls 29 and 31) a bottom wall 36 and a top wall 38 which, together with walls 29 and 31, defining region 28 (at upstream portion 30 thereof) and fluid channel 34. It can be seen that interconnected region 28, at upstream portion 30, includes two separate sections, separated by fluid channel 34. The separate sections are interconnected further downstream.

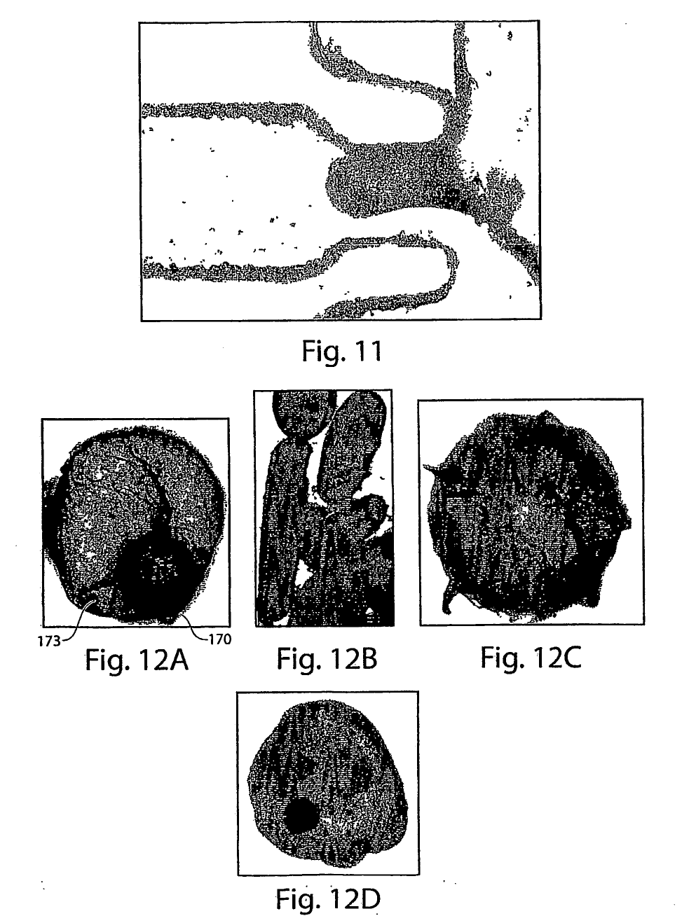

Referring again to FIG. 5, interconnected region 28 includes a dimensionally-restricted section 40 formed by extensions 42 extending from side walls 29 into the interconnected region. Fluid flowing from upstream portion 30 to downstream portion 32 of the interconnected region must pass through dimensionally-restricted section 40 in the embodiment illustrated. Outlet 37 of fluid channel 34 is positioned upstream of the dimensionally-restricted section. In the embodiment illustrated, the downstream portion of interconnected region 28 has a central axis 44, which is the same as the central axis of fluid channel 34. That is, the fluid channel is positioned to release fluid for the fluidic droplet upstream of the dimensionally-restricted section, and in line with the dimensionally-restricted section. As arranged as shown in FIG. 5, fluid channel 34 releases the fluid into an interior portion of interconnected region 28. That is, the outer boundaries of the interconnected region are exterior of the outer boundaries of the fluid channel 34. At the precise point at which fluid flowing downstream in the interconnected region meets fluid released from the fluid channel, the fluid forming the fluidic droplet is surrounded at least in part by the fluid in the interconnected region, but is not completely surrounded by fluid in the interconnected region. Instead, it is surrounded through approximately 50% of its circumference, in the embodiment illustrated. Portions of the circumference of the fluidic droplet are constrained by bottom wall 36 and top wall 38. A photomicrograph of a similar device is illustrated in FIG. 11.

In the embodiments illustrated, the dimensionally-restricted section is an annular orifice, but it can take any of a varieties of forms. For example, it can be elongate, ovoid, square, or the like. Preferably, it is shaped in any way that causes the dispersing fluid to surround and constrict the cross-sectional shape of the fluid forming the fluidic droplet. The dimensionally-restricted section is non-valved in preferred embodiments. That is, it is an orifice that cannot be switched between an open state and a closed state, and typically is of fixed size. In some embodiments, the size of the dimensionally-restricted section may be used to control the size of the fluidic droplet formed from the dimensionally-restricted section.

Although not shown in FIGS. 5 and 6, one or more intermediate fluid channels can be provided in the arrangement of FIGS. 5 and 6 to provide an encapsulating fluid (e.g., containing particles), surrounding portions of the fluid forming the fluidic droplet produced by action of the surrounding fluid. In one embodiment, two intermediate fluid channels are provided, one on each side of fluid channel 34, each with an outlet near the outlet of the fluid channel. Thus, particles may be directed to the fluid-fluid interface growing in the dimensionally-restricted section through the use of such channels. The flow of the continuous phase liquid may focus the fluid forming the fluidic droplets into a narrow thread and target the particles onto the fluid-fluid interface. This flow configuration may provide kinetic energy to the particles, and the collision of the particles with the interface may induce adsorption. Repetition can result in the build-up of particles in a close-packed shell surrounding the forming fluidic droplet. In some cases, the particles will stack in parallel lines closely following the flow of the continuous or surrounding phase (see, e.g., FIG. 1E).

In another aspect of the invention, certain gaseous droplets comprising particles distributed on the surface of the droplets can be prepared by providing particles on a surface to form a porous layer, then adding a liquid to the porous layer to entrap gas (e.g., air) between the particles. For example, the liquid may be water, an aqueous solution, etc. In some cases, the gas may be air; in other cases, however, other gases may be used, for example, but not limited to, CO₂, O₂, N₂, noble gases such as Ar, Kr, Ne, etc., or the like. For instance, the droplets may be surrounded by a gas such as argon, before entrapment of the gas within the porous layer with the liquid. The liquid may penetrate the porous layer until infiltration halts due to capillary pressure. Thus, a monolayer of particles is trapped at a gas/liquid interface. By shaping the monolayer, e.g., mechanically, spherical and/or non-spherical fluidic droplets comprising particles distributed on the surface may be formed. In some cases, the fluidic droplets may be encapsulated by one, two, or more layers of particles.

The present invention finds use in the wide variety of applications. For example, certain aspects of the invention may be used in biological applications. For instance, a fluidic droplet comprising a particle, for example, a colloidal capsule, may be used for drug delivery applications, i.e., where a composition of the invention is delivered to a subject, for example, a human or non-human animal. Examples of subjects include, but are not limited to, a mammal such as a dog, a cat, a horse, a donkey, a rabbit, a cow, a pig, a sheep, a goat, a rat, a mouse, a guinea pig, a hamster, a primate (e.g., a monkey, a chimpanzee, a baboon, an ape, a gorilla, etc.), or the like; a bird; a reptile; or an amphibian such as a toad, a frog, etc. In some embodiments, a drug may be contained with the fluidic droplet and/or within the particles. The fluidic droplet comprising the particles may be delivered to the bloodstream (e.g., through injection), to the lungs, etc. Examples of parenteral injection modalities that can be used with the invention include intravenous, intradermal, subcutaneous, intracavity, intramuscular, intraperitoneal, epidural, or intrathecal delivery. Examples of drugs potentially suitable for such delivery mechanisms include, but are not limited to, small molecule compounds (e.g., having a molecular weight of less than about 1000 Da or about 2000 Da, for instance, albuterol), peptide or proteins (e.g., insulin, human growth hormone, erythropoietin, granulocyte-colony stimulating factor or G-CSF, etc.), or the like. In some cases, some of the particles may include antibodies or other targeting entities, which may direct the fluidic droplets comprising the particles to a specific location or organ within the body. Those of ordinary skill in the art will know of systems and methods for attaching an antibody to a particle, etc. In certain instances, the particles may include other biological entities, for example, proteins or peptides, antibodies, cells, or the like.

In some embodiments, the particles and/or the fluidic droplet may be supplied in conjunction with one or more pharmaceutically acceptable carriers. Pharmaceutically acceptable carriers are well-known to those of ordinary skill in the art. As used herein, a “pharmaceutically acceptable carrier” refers to a non-toxic material that does not significantly interfere with the effectiveness of the biological activity of the active compound(s) to be administered, but is used as a formulation ingredient, for example, to stabilize or protect the active compound(s) within the composition before use. The term “carrier” denotes an organic or inorganic ingredient, which may be natural or synthetic, with which one or more active compounds of the invention are combined to facilitate the application of the composition. The carrier may be co-mingled or otherwise mixed with one or more active compounds of the present invention, and with each other, in a manner such that there is no interaction which would substantially impair the desired pharmaceutical efficacy. Pharmaceutically acceptable carriers include, for example, diluents, emulsifiers, fillers, salts, buffers, excipients, drying agents, antioxidants, preservatives, binding agents, bulking agents, chelating agents, stabilizers, solubilizers, silicas, and other materials well-known in the art.

In yet another set of embodiments of the invention, the particles and/or the fluidic droplet may contain catalysts, for example, to facilitate chemical reactions or other similar applications. The fluidic droplets comprising particles may have a large surface area, which facilitates such reactions or catalysis. As a non-limiting example, the catalysts may be used to treat wastewater. For instance, the particles surrounding the fluidic droplet may comprise activated carbon.

As another application, fluidic droplets comprising particles, such as fluidic droplets encapsulated with particles may be used for reclamation, for instance, of environmental water. For example, the droplets can be prepared by placing titania or other nanometer sized particle catalysts onto a fluidic droplet. The catalyst particle shell may thus be on the mesoscale (e.g., greater than the nanometer scale), while still maintaining the individual structure and advantages of the nanometer sized particles (e.g., increase reaction surface area or higher reaction rates). Such catalyst particles may allow quicker catalyst particle reclamation, as the larger fluidic droplets may be easier to separate than nanoparticles, which can take months to sediment and clarify from solution using sedimentation. For instance, for gas bubbles or less dense liquids, the fluidic droplets having the particles may be allowed to naturally rise to the surface of a treated water sample (e.g., by creating differences in density or buoyancy), and such droplets can be separated for removal and recycling. As another example, more dense liquids can be used, such that the fluidic droplets sediment to the bottom of the sample for reclamation. As yet another example, one or more magnetic particles can be placed on the shell, such that the shell may be directed by an outside magnetic or electric field.

In another set of embodiments of the invention, fluidic droplets comprising particles, such as fluidic droplets encapsulated with particles, may be used as contrast agents, for instance, ultrasound contrast agents. In general, contrast agents are agents having a relatively high contrast with respect to a particular application (e.g., ultrasound). For instance, the fluidic bubbles may improve the image quality of ultrasound by decreasing the reflectivity of undesired interfaces, and/or by increasing backscattering echoes. In some cases, a monodisperse distribution of fluidic droplets comprising particles may be used as a contrast agent.

In still another set of embodiments, the fluidic droplets comprising particles may be used as sunscreen. In one embodiment, an light absorbing entity (e.g., for ultraviolet light), and/or a light scattering entity, may be incorporated within the particles and/or within the fluidic droplet. If the light absorbing entity and/or a light scattering entity is contained within the fluidic droplet, the entity(ies) may be prevented from exiting the fluidic droplet and/or contacting a subject or other external surface, due to the particles encapsulating the fluidic droplet. As discussed herein, in some cases, the particles may also prevent aggregation of the fluidic droplets from occurring. In another embodiment, the fluidic droplet may contain a gas such as air, which may be act as an effective light scatterer and/or diffuser. In yet another embodiment, the particles and/or the fluidic droplet may contain titania or other suitable sunscreen agents.

As mentioned above, in some, but not all embodiments, the systems and methods described herein may include one or more microfluidic components, for example, one or more microfluidic channels. “Microfluidic,” as used herein, refers to a device, apparatus or system including at least one fluid channel having a cross-sectional dimension of less than about 1 mm, and a ratio of length to largest cross-sectional dimension of at least 3:1. A “microfluidic channel,” as used herein, is a channel meeting these criteria. The “cross-sectional dimension” of the channel is measured perpendicular to the direction of fluid flow within the channel. Thus, some or all of the fluid channels in microfluidic embodiments of the invention may have maximum cross-sectional dimensions less than about 2 mm, and in certain cases, less than about 1 mm. In one set of embodiments, all fluid channels containing embodiments of the invention are microfluidic or have a largest cross sectional dimension of no more than about 2 mm or about 1 mm. In certain embodiments, the fluid channels may be formed in part by a single component (e.g. an etched substrate or molded unit). Of course, larger channels, tubes, chambers, reservoirs, etc. can be used to store fluids and/or deliver fluids to various components or systems of the invention. In one set of embodiments, the maximum cross-sectional dimension of the channel(s) containing embodiments of the invention is less than about 500 microns, less than about 200 microns, less than about 100 microns, less than about 50 microns, or less than about 25 microns.

A “channel,” as used herein, means a feature on or in an article or substrate that at least partially directs flow of a fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and/or outlet(s). A channel may also have an aspect ratio (length to average cross sectional dimension) of at least 2:1, more typically at least 3:1, 5:1, 10:1, 15:1, 20:1, or more. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus).

The channel may be of any size, for example, having a largest dimension perpendicular to fluid flow of less than about 5 mm or about 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In some cases the dimensions of the channel may be chosen such that fluid is able to freely flow through the article or substrate. The dimensions of the channel may also be chosen, for example, to allow a certain volumetric or linear flowrate of fluid in the channel. Of course, the number of channels and the shape of the channels can be varied by any method known to those of ordinary skill in the art. In some cases, more than one channel or capillary may be used. For example, two or more channels may be used, where they are positioned inside each other, positioned adjacent to each other, positioned to intersect with each other, etc.

A variety of materials and methods, according to certain aspects of the invention, can be used to form any of the above-described components of the systems and devices of the invention. In some cases, the various materials selected lend themselves to various methods. For example, various components of the invention can be formed from solid materials, in which the channels can be formed via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al). In one embodiment, at least a portion of the fluidic system is formed of silicon by etching features in a silicon chip. Technologies for precise and efficient fabrication of various fluidic systems and devices of the invention from silicon are known. In another embodiment, various components of the systems and devices of the invention can be formed of a polymer, for example, an elastomeric polymer such as polydimethylsiloxane (“PDMS”), polytetrafluoroethylene (“PTFE” or Teflon®), or the like.

Different components can be fabricated of different materials. For example, a base portion including a bottom wall and side walls can be fabricated from an opaque material such as silicon or PDMS, and a top portion can be fabricated from a transparent or at least partially transparent material, such as glass or a transparent polymer, for observation and/or control of the fluidic process. Components can be coated so as to expose a desired chemical functionality to fluids that contact interior channel walls, where the base supporting material does not have a precise, desired functionality. For example, components can be fabricated as illustrated, with interior channel walls coated with another material. Material used to fabricate various components of the systems and devices of the invention, e.g., materials used to coat interior walls of fluid channels, may desirably be selected from among those materials that will not adversely affect or be affected by fluid flowing through the fluidic system, e.g., material(s) that is chemically inert in the presence of fluids to be used within the device.

In one embodiment, various components of the invention are fabricated from polymeric and/or flexible and/or elastomeric materials, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, or mixture of such polymers heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers are preferred in one set of embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of the microfluidic structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour. Also, silicone polymers, such as PDMS, can be elastomeric and thus may be useful for forming very small features with relatively high aspect ratios, necessary in certain embodiments of the invention. Flexible (e.g., elastomeric) molds or masters can be advantageous in this regard.

One advantage of forming structures such as microfluidic structures of the invention from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, components can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy et al.), incorporated herein by reference.

Another advantage to forming microfluidic structures of the invention (or interior, fluid-contacting surfaces) from oxidized silicone polymers is that these surfaces can be much more hydrophilic than the surfaces of typical elastomeric polymers (where a hydrophilic interior surface is desired). Such hydrophilic channel surfaces can thus be more easily filled and wetted with aqueous solutions than can structures comprised of typical, unoxidized elastomeric polymers or other hydrophobic materials.

In one embodiment, a bottom wall is formed of a material different from one or more side walls or a top wall, or other components. For example, the interior surface of a bottom wall can comprise the surface of a silicon wafer or microchip, or other substrate. Other components can, as described above, be sealed to such alternative substrates. Where it is desired to seal a component comprising a silicone polymer (e.g. PDMS) to a substrate (bottom wall) of different material, the substrate may be selected from the group of materials to which oxidized silicone polymer is able to irreversibly seal (e.g., glass, silicon, silicon oxide, quartz, silicon nitride, polyethylene, polystyrene, epoxy polymers, and glassy carbon surfaces which have been oxidized). Alternatively, other sealing techniques can be used, as would be apparent to those of ordinary skill in the art, including, but not limited to, the use of separate adhesives, thermal bonding, solvent bonding, ultrasonic welding, etc.

The following examples are intended to illustrate certain embodiments of the present invention, but do not exemplify the full scope of the invention.

### EXAMPLE 1

This example illustrates a microfluidic approach for the formation of close-packed colloidal shells, which allows precise control of size, and mechanical, chemical, and/or dielectric properties. In this example, fluidic droplets containing colloidal particles were synthesized in situ by a hydrodynamic focusing device in which unmodified colloidal particles are targeted at a growing fluid-fluid interface.

FIG. 1 shows an example of a colloidal assembly at a growing air/water interface. The inner phase is air, while a 0.1% by volume suspension of charge-stabilized 4 micron diameter fluorescent polystyrene beads (to facilitate visualization) was chosen as the continuous phase. FIG. 1A is a picture of a flow-focusing device used in this example for flow-driven assembly of the colloidal droplets. The dispersed phase was injected through the central channel, while the continuous phase containing the particles was injected through the side channels. The flow of the continuous phase liquid focused the dispersed phase fluid into a narrow thread and targeted the particles onto the interface. A 1 mm×1 mm view chamber was constructed at the end of the device.

This flow configuration provided kinetic energy to the particles, and the collision of the particles with the interface induced adsorption. FIGS. 1B-1D show a time-lapse sequence of the capture of an individual particle. A particle (indicated with an arrow) approached the interface at a speed of 10 cm/s in FIG. 1B and adsorbed at the interface in FIG. 1C. The shear experienced by the particle from the flow drove it to a stagnation point at the anterior of the capsule. In FIG. 1D, the particle movement was stopped by previously stacked particles. The apparent minor size differential of the droplets is due to the different heights of the droplets from the focal plain of the objective. The droplets do not coalesce even when in contact, and appear to be indefinitely stable.

Repeated capture and transport events resulted in a rapid build up of particles in a close-packed shell, with the particles stacking in parallel lines closely following the flow of the continuous phase (FIG. 1E). In the absence of flow, the spontaneous adsorption of micron size particles onto emulsion droplets to form particle shells was not observed. The geometry of the focusing device ensured that particle capture occurred far from the growing droplet, which avoided steric and electrostatic repulsions a particle would otherwise experience when it directly approaches a shell. Occasional missing particles along a stack caused rearrangements through the tumbling of adjacent particles, which thus self-healed most defects in the interfacial packing, though defects associated with packing particles on a spherical topology may be still present in some cases.

Particles continued to accumulate at the end of the gas thread, which eventually became unstable, and pinched off to produce a fluidic droplet comprising the particles (FIGS. 1F-1G). These figures show that the growing particle shell resulted in greater shear on the proto-capsule (FIG. 1F) and the thread experienced an instability, causing the capsule to break off (FIG. 1G).

The shear experienced by the particles from the surrounding fluid was found to be insufficient to detach adsorbed particles from the interface. In addition, the shear-driven breakage of the droplet made the geometry of the channel an important determinant of the size of the droplet, and the continuous one-step assembly could produce generally monodisperse gas droplets (FIG. 1H). The targeted delivery of the suspension increased the efficiency of interfacial attachments, and thus allowed the use of extremely dilute colloidal solutions, which may allow the formation of droplets using precious or rare colloidal particles, etc.

For colloidal capsules composed of Brownian particles such as 1 micron polystyrene particles, thermal diffusion apparent in the bulk phase was observed to be arrested in the tightly packed shell. This observation is in contrast with previously reported particle shells, where Brownian motion of the particles is often observed on the droplet interface. The high particle interfacial densities obtained through the targeted delivery described in this example resulted in spontaneous jamming of the particles. Based on many experiments with different materials for the continuous and dispersed phases and for the particles (data not shown), this topologically induced jamming appeared to be generally independent of the nature of the particle-particle interactions. However, the shell still exhibited mostly hexagonal packing, due to the self-healing of defects during the assembly. This particle shell was found to be intrinsically stable, and spontaneous coalescence of the fully encased droplets was not observed (FIG. 1H, which shows monodisperse stable colloidal capsules arrayed along a gas/water interface in a viewing chamber). Thus, shells produced through this method of flow-driven assembly do not require thermal sintering or chemical locking to maintain their integrity.

Flow-driven assembly also may allow the production of droplets with a wide range of characteristics without surface modifications of the colloidal particles. For instance, there is an energy reduction ΔE when a particle of radius r adsorbs on a fluid-fluid interface of surface tension γ:

ΔE=πγr²(1±cos θ)²,

where θ is the contact angle of the particle measured through the aqueous phase. Typically, nanometer-size hydrophilic particles, such as silica spheres suspended in water, can be chemically modified to increase hydrophobicity (increasing θ), before adsorption is observed at the fluid-fluid interface, e.g., at the air-water interface or at the interface of oil droplets (data not shown).

An alternative method of stabilizing particles at the interface is to increase the dimensions of particle. The energetic barrier to adsorption may increase with increased total charge, i.e. with larger particles (assuming constant surface charge density). This increased energetic cost of forcing micron-sized particles can be provided, for example, by flow-driven assembly. For instance, air and oil droplets can be prepared with unmodified silica particles initially dispersed in water. Also, droplets produced with micron-sized hydrophilic silica and gold particles can be as stable as those produced from hydrophobic polystyrene, and similar arrest of particle Brownian motion was also observed. Thus, shell/core combinations, such as a fully hydrophobic shell around a hydrophilic core and vice versa, can be easily produced. As another example, a colloidal capsule was prepared using unmodified conductive metallic particles, as is shown in FIGS. 7A-7B. The droplets may have various dielectric properties that can be obtained by varying the conductivity of the particles, and/or the ratio of conductive and insulating particles on the interface; in the case of a fully conductive shell, the fluid core can be protected from stray electromagnetic fields in certain cases (analogous to a Faraday cage).

Additionally, individual oil droplets, when placed in the fusion chamber with a suspension of unmodified 1.0 micrometer polystyrene particles, did not get covered in the absence of hydrodynamic flow. Additional HCl added up to a final concentration of 1.0 M resulted in bulk aggregation, but the aggregates did not adsorb and cover the droplets. Gentle agitation was then performed to rule out absence of coverage due to particle sedimentation. Coverage was not achieved. More forceful agitation, however, produced covered droplets. Thus, colloidal shell production may require specific input of energy through hydrodynamic flows to overcome barriers to adsorption and close-packing in some cases. The production of previous colloidal shells described in the literature, which was always in batch concomitant with the necessary emulsification steps, may have obscured this energetic barrier to the production of colloidal shells. The hydrodynamic flows and mixing produced may result in such coverage, which from the vantage point of post-synthesis appears to be a self-assembled system.

In these experiments, surfactant-free fluorescent polystyrene particles (IDC Corporation) were diluted with purified water (Millipore) to a typical concentration of less than 0.1% v/w. The particles were described as being hydrophobic with a small amount of surface charge providing colloidal stability in suspension.

The microfluidic device was manufactured using principles of soft-lithography. Briefly, a negative mask was placed on a silicon wafer spin-coated with a 50 micron thick layer of SU-8 and exposed to UV light. The cross-linked design was then developed to obtain a positive mold, and liquid PDMS is poured over the mold. The PDMS mold was cured and peeled-off the mold and inlet holes were bored with custom prepared 20 G needles. The mold was irreversibly bonded to a glass slide or a slab of PDMS to produce the device. Gas tight syringes (Hamilton) were filled with various colloidal suspensions, depending on the particular experiment, and were connected to a compressed air tank through custom adapters. PE 20 tubes were connected from the syringe needle to the continuous phase inlet hole of the device. A similar needle, without the suspension, was connected to the dispersed phase inlet hole of the device. Pressure applied to the needles was independently controlled by a regulator with a precision of 0.001 psi. Typically, the continuous phase was injected at a pressure of 1.92 psi and the dispersed phase was injected at a pressure of 1.69 psi. Formation of the armored or encapsulated droplets was visualized with a high-speed CMOS camera (Vision Research) at 70,000 fps. Fully armored droplets (i.e., such that the particles substantially covered the surface of the droplets) were produced at a frequency of 3 droplets per second. Though not necessary, a small amount of HCl (typically 10 mM) was found to increase the coverage and production frequency.

Over certain pressure ranges, incomplete coverage of the gas droplets was observed, and the gas droplets fused in the viewing chamber to spontaneously produce larger more fully covered droplets. The dispersed phase used varied. Droplets were produced with gaseous Ar, CO₂, O₂, N₂, and liquid mineral oil (Sigma) and octanol (Sigma). The colloidal particles also varied. Monodisperse polystyrene particles were used of 1.6 micron, 2.1 micron, 4.0 micron, and 4.6 micron diameter. Also used were 1.6 microns diameter silica particles (Bangs Lab), 1.0 micron diameter PMMA (polymethylmethacrylate) particles (Bangs Lab), and polydisperse gold microparticles, with mean diameter ranging from 1.0-3.99 micron (Sigma). All the particles were diluted with ultrapure water to typical concentrations of 0.1% v/w. Lower concentrations of colloidal particles were also used, but lower production frequencies have to be enforced to ensure complete coverage of the drops produced.

The cell perfusion chambers (Molecular Probes) were bonded onto a microscope slide (Corning Glassworks). 100 microliter of a suspension containing the armored droplets were introduced into the perfusion chamber. 50 microliter of Triton-X100 (Sigma) solution at a concentration of 17 mM was introduced into the perfusion chamber and allowed to diffuse to the armored droplets. Movies of the release process were taken with a Phantom V5 camera (Vision Research).

### EXAMPLE 2

In this example, the coalescence of emulsion droplets is used to illustrate close-packing of particles on the surface (fluidic interface) of a fluidic droplet. For example, the coalescence of two generally spherical incompressible parent droplets produces a spherical daughter droplet with a surface area to volume ratio that is 2^{-1/3}, or 20%, smaller than that of the sum of the two parent droplets. If particles are present, the deep energy well that retains the micron-sized colloidal particles on the interface prevents particles from escaping into the dispersed or continuous phase; therefore the interfacial particle density increases upon coalescence.

In this example, fluidic droplets containing particles were produced with excess surface area through controlled fusion of close-packed fluidic droplets comprising particles, using techniques similar to those described in Example 1. A glass fusion chamber was constructed that was composed of two opposing fixed and two moveable side plates. FIG. 2E is a schematic diagram of the fusion chamber used in this experiment. The droplets were stressed by squeezing the two side plates together. The top plate confined the droplets with the rectangular chamber formed by the edges of the side plates. The translation of the moveable side plates, which is lubricated by a thin aqueous layer from the continuous phase, allowed the application of external forces on the fluidic droplets.

The compressed fluidic droplet was observed to deform elastically and adopt a non-spherical geometry with increased surface area. FIGS. 2A and 2B illustrate two gas bubbles comprising particles induced to fuse by deforming them between two glass plates. All of the objects in FIG. 2 were gas-filled and encapsulated with florescent polystyrene particles. For spherical topologies, it is believed an isotropic stress on the particles may be applied by modifying the surface area for a given number density of interfacial particles, such that external compression of the closed surface results in an anisotropic distribution of surface stresses that decreases the interfacial particle density. Thus, the deformation exposes regions of the droplets that did not contain colloidal particles (FIG. 2A), such that the contact of two or more such forcibly exposed interfaces lead to the spontaneous fusion of the fluid cores (FIG. 2B). When the side plates were pulled apart, the surface area constraints introduced by the now-fused droplets prevented the daughter fluidic droplet from relaxing elastically, producing a prolate ellipsoid or an elongated cigar shape (FIG. 2C). The controlled coalescence of droplets can be continued. For example, the consecutive fusion of many such fluidic droplets produced highly elongated cigar-shaped shells (FIG. 2D, a fluorescent photomicrograph) that reached several millimeters in length (the diameter is approximately that of the initial drops). These fluidic droplets were able to retain the prolate ellipsoid shape when left undisturbed (FIG. 2D); such shapes could not typically be maintained by a fluidic droplet free of particles. These figures also show that the anisotropy induced by the external stress on the droplet interface was supported by force chains of the jammed droplets, even when the applied stress was removed.

The ability of the particles to constrain the droplets in highly anisotropic shapes suggests the presence of intrinsic mechanical properties that oppose the restoring force of surface tension. In these systems, strain-baring force change may arise in response to external stresses. For instance, in the case of the fused ellipsoid, the anisotropy introduced by the fusion event is supported by the formation of these force changes, which can then support the prolate shape in the absence of the external stress. However, these stress chains may be fragile in some cases, and even small non-compatible stresses may be sufficient to cause chain collapse and plastic rearrangement of the particles within the fluidic droplet. In another set of experiments, fusion chambers were used to probe the mechanical properties of these droplets. An example is illustrated in FIGS. 3A-3D. In FIG. 3A, an ellipsoidal gas droplet is subjected to compression between two plates within a gas chamber. In FIGS. 3B and 3C, the droplet undergoes plastic rearrangement of the force chains to accommodate the compressive stress. This plastic accommodation is extensive, as the gas droplet compresses to a generally cuboidal shape before extending a major axis access orthogonal to that of the pre-compressed object, as is shown in FIG. 3D. The ellipsoid produced was observed to be stable in its new configuration, even when the side plates were removed from direct contact but the gas droplet. This plastic accommodation of outside stresses appears to confer resistance to sheer-induced coalescence of individual fluidic droplets.

A four hundred micron long gas ellipsoid, when subjected to a compressive force, was observed to beplastically rearranged, transitioning from a generally cuboidal droplet to an ellipsoid with a major access orthogonal to the pre-stressed object, as is shown in FIGS. 3A-3C. Higher aspect ratio objects filled with an incompressible liquid axial compression may result in a buckling instability and localized wrinkling (FIGS. 3E-3G). The cigar-shaped oil droplet was subjected to a deforming force acting along its major axis so that the ellipsoid appeared to initially bend (FIG. 3F) with apparently large folds (FIG. 3G). For higher stresses, the particles were observed to rearrange and flow on the surface of the fluidic droplet along with the internal liquid phase to accommodate the increased strain. In FIG. 3H, the central portion grew further, with extremely apparent folding continued deformation pushes some of the droplet under the glass plate, emptying it of oil, and when the plate was removed, a less elongated, handled ellipsoid with apparent folding was produced. It is believed that removal of the stress resulted in the immediate jamming of the particles in their new positions, preventing elastic restitution of the fluidic droplet and thus freezing its shape. The shear-induced, solid-to-liquid transition resulted in plastic deformation of the stressed fluidic droplet, and confers a strain-history dependence on the shape of droplets (FIGS. 3G-3H). The plasticity of the fluidic droplet thus allowed extensive reshaping of the surface when anisotropic forces were applied. Thus, these fluidic droplets comprising particles have a degree of plasticity and mechanical resistance never observed before for emulsion droplets or gas bubbles.

The fusion of two fluidic droplets produced an object with excess surface area for the volume enclosed. Such non-spherical and/or folded fluidic droplets have the advantage of being able to change their volume due to chemical or thermal modulations. These fused objects were also found to be resistant to shear induced coalescence; instead of exposing the interface, the particles flowed to accommodate the applied stress.

In this example, the fusion chamber was prepared as follows. Borosilicate glass slides 50×70 mm (Corning Glassworks) were placed on the stage of an inverted microscope (IRB-M, Leica). Two 24×60 mm cover slips (Corning Glassworks) were placed on the microscope slide to act as side walls of a small chamber. Typically, between the slides, 100 microliter of a solution containing the capsules made in the microfluidic device was introduced. Another glass slide was placed on top of this assembly to form a closed chamber. Manual translation of the side walls allowed the production of large deformations of the trapped droplets, which allowed fusion to occur to produce ellipsoidal droplets. Similarly, the mechanical properties of the now fused droplets were probed by placing the ellipsoids between the moving plates and subjecting them to the forces outlined above. The droplets could be extensively reshaped and various anisotropic shapes were easily produced. The droplets were observed to maintain their shape for at least one hour, and most likely much longer.

Finally, uncovered droplets of oil and gas were introduced in some experiments into the fusion device and efficiently coated through rapid translation of the side plates. This procedure allowed the droplets to be coated with dense particles, such as gold, calcium carbonate, or titanium oxide particles. These particles sedimented rapidly when suspended in water, which prevented efficient loading into the syringes. Squeeze flows produced in the device were akin to the hydrodynamic flow in the microfluidic flow-focusing device.

### EXAMPLE 3

This example illustrates that fluidic droplets could be refluidized by modifying the forces trapping the particles at the fluidic interface of the droplets. The addition of a surfactant (ionic or non-ionic) to a solution containing fluidic droplets having jammed shells formed from 1 micron diameter polystyrene particles resulted in an instability that ended in the complete disassembly of the colloidal shell (FIG. 4), thereby refluidizing the droplet. Initially, a 50 micron droplet comprising 1.6 micron diameter fluorescent polystyrene beads was used (FIG. 4A). The particles were jammed on the interface in a polycrystalline lattice, using techniques similar to those described in Example 1. Triton® X (octyl phenol ethoxylate) solution was introduced at the end of a perfusion chamber and allowed to diffuse to the particles. The Triton® X solution was at a concentration of 17 mM. The CMC or critical micelle concentration was 0.3 mM. The arrival of surfactant molecules to the fluidic droplets was signaled by the increase of the lateral mobility of individual particles and the rearrangement of the initially jammed polycrystalline domains. Some of the particles were observed to be ejected from the particles. The ejection of the particles from the surface unjammed the particles (FIG. 4B), and the droplet resumed fluid-like behavior and begins to reorder the polycrystalline domains, which lead to the complete disassembly of particles from the interface (FIG. 4C). Large-scale rearrangement led to individual particles being ejected from the interface. The released particles did not flocculate, and Brownian motion of the particles was evident. The bubble was also able to release its contents. Continuous absorption of surfaced resulted in the complete destabilization of the interface. The released particles retained colloidal stability and resumed Brownian most envault come out, which suggested that the particles were not aggregated on the fluidic droplet interface.

It is believed that the jammed state of the particles is important to the release mechanism shown in FIG. 4. Surfactant molecules adsorbed to the hydrophobic polystyrene surface and the gas/water interface. The reduced surface tension due to the presence of the surfactant molecules at the bubble interface reduced the energy cost of creating an air/water interface. Also, the particles became relatively more hydrophilic with the presence of surfactant (i.e., contact angle decreases), and recalling the equation for ΔE, this may reduce the stability of the particles on the fluid-fluid interface with the fluidic droplet and the surrounding fluid. These factors may allow the droplet to refluidize; the high stress state of the jammed particles and the repulsive interactions of the charged particles can result in rearrangement and ejection of stressed particles from the fluidic droplet. Continuous adsorption of the surfactant may lower the interfacial well that holds the particle at the fluid-fluid interface until eventually thermal energy is sufficient to detach most or all of the particles from the fluid-fluid interface with the fluidic droplet and the surrounding fluid.

### EXAMPLE 4

In this example, additional fluidic droplets comprising particles, such as colloidal particles, are described. In FIG. 8A, is a diagram of a flow-driven assembly process is illustrated. In this figure, system 100 includes first channel 101, second channel 102, and third channel 103, which connect to form exit channel 105. Channel 101 includes a first gas or liquid, while channels 102 and 103 each contain particles, which may be suspended in a liquid. In this embodiment, channel 102 carries particles 112, while channel 103 carries particles 113. In other embodiments, more than one type of particle may be present within channels 102 and/or 103, and the type and/or distribution of particles within channels 102 and 103 may be the same or different. Within the channels, the direction of fluid flow is indicated by arrows 107. At the junction of the channels, the particles are directed to the surface of the liquid exiting channel 101, causing the formation of a fluidic droplet surrounded by a shell of particles. In this figure, fluidic droplet 120 is in the process of being formed, in which one half of the fluidic droplet is covered by particles 112, while the other half of the fluidic droplet is covered by particles 113. The resulting droplet, indicated by fluidic droplet 121, can also be referred to a “Janus” droplet.

Another embodiment is illustrated in FIG. 8B. In this embodiment system, 100 includes channels 101, 102, and 103, which connect to form exit channel 105. Channel 101 includes a gas or liquid, which is used to produce the fluidic droplets. Channels 102 and 103 each contain particles in this example. As illustrated, channels 102 and 103 each contain particles 112. However, in other embodiments, the particles within channels 102 and 103 may be different, or one of the channels may be free of particles. System 100 also includes channels 104 and 106. Channel 104 connects to channel 102, while channel 106 connects to channel 103. Channels 104 and/or channel 106 may also contain particles and/or fluids, and these particles and/or fluids may be the same as, or different than, the fluids and/or particles within channels 102 and 103. The distribution of particles within channels 102 and 103 can be independently controlled through the use of valves 131, 132, 133, and 134. Each of these valves can be independently controlled as desired. As shown in FIG. 8B, valve 131 is set to “on,” blocking fluidic flow from channel 104 into channel 102. Similarly, valve 134 is also on, thereby blocking the flow of fluid from channel 106 into channel 103. Valves 132 and 133 are set to “off,” allowing fluid to flow through channels 102 and 103. By controlling the distribution of particles within channels 102 and 103, for example through the manipulation of valves 131, 132, 133, and 134, the layering of the particles in forming droplet 120 can be controlled, for example, such that a layered arraignment of particles is achieved, as is illustrated by fluidic droplet 121, which contains more than one type of particle on its surface, distributed in a heterogeneous, layered manner.

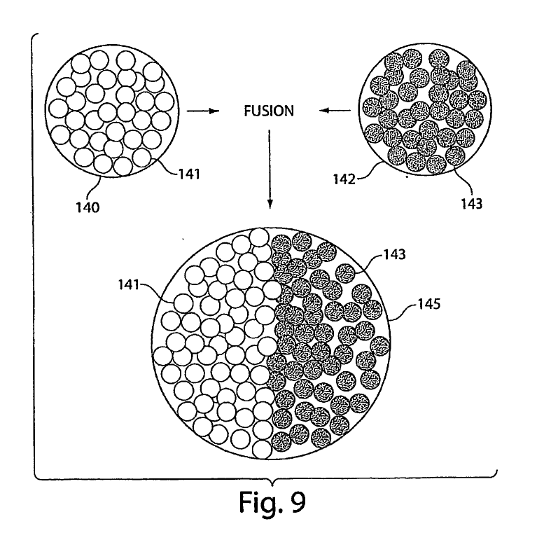

Another method of creating a fluidic particle having a heterogeneous distribution on its surface is illustrated FIG. 9. In this example, fluidic droplets 140 and 142 are fused together to form Janus droplet 145. Fluidic droplet 140 has a distribution of particles 141 on its surface, while fluidic droplet 142 has a distribution of particles 143 on its surface. After the fluidic droplets have fused together to form droplet 145, particles 141 and 143 are arranged in a heterogeneous manner, i.e., one half of the surface of fluidic droplet 145 is covered with particles 141, while the other half is covered with particles 143. Of course, in other embodiments, other distributions of particles are possible. For example, there may be particles contained within fluidic droplets 140 and/or 142, more than one type of particle may be present in droplets 140 and/or 142 (internally and/or externally), etc. Other examples include the fusing of fluidic droplets that are ellipsoidal or have other shapes, e.g., using the systems and methods as described herein.

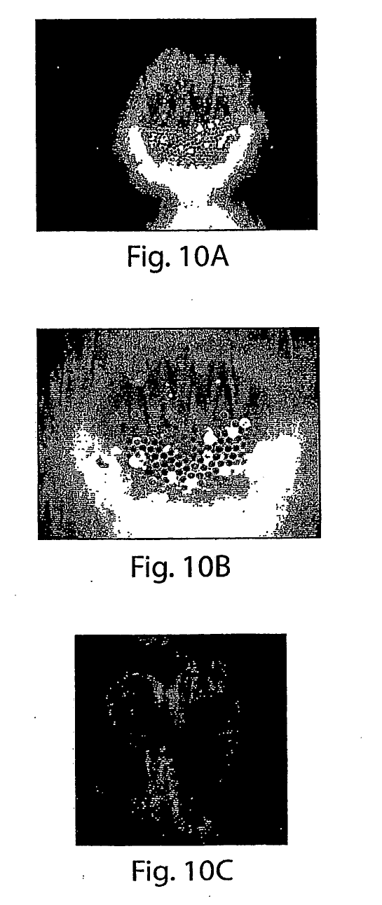

Examples of such particles are illustrated in FIGS. 10A-10C. In FIG. 10A, a Janus droplet is illustrated, where roughly one half of the surface of the fluidic droplet is covered with a first type of particle, and the other half of the fluidic droplet is covered with a second type of particle. In this figure, the particles have different sizes, i.e., the smaller particles have a diameter of 1.6 microns, while the larger particles have a diameter of 5.0 microns. The fluidic droplets in FIGS. 10A and 10B have different diameters. In FIG. 10C, a non-conventional shell geometry is shown, created by fusing various particle-covered droplets. In this figure, the fluid within the fluidic droplet is air, while the colloidal particles on the surface of the fluidic droplet are composed of 2.1 micron diameter polystyrene particles.

### EXAMPLE 5

This example illustrates various fluidic droplets produced according to certain embodiments of the invention. In FIG. 12A, a double capsule structure is shown, in which an inner gas bubble 170 is encapsulated within an oil droplet 173. Both the inner gas and the outer oil droplets each are encapsulated with particles. In this photomicrograph, the inner gas bubble is encapsulated with colloidal polystyrene particles, and the outer, oil fluid droplet is also encapsulated within colloidal polystyrene particles. Thus, complex, multi-encapsulated objects, having alternating fluidic phases and/or particle phases, can be created using the systems and techniques of the invention, as described herein.

In FIG. 12B, an elongated fluidic droplet, encapsulated within particles, was created by fusing two fully encapsulated fluidic droplets together. The fused capsule accommodates the excess surface area created when the fluidic particles fuse, by expansion of the gas into the new volume, thereby reducing the internal pressure.

For a liquid droplet, as is illustrated in FIG. 12C, the particles encapsulating the fluidic droplet may adopt a highly folded structure to accommodate the excess surface that is created when two encapsulated fluidic droplets are fused together. Both fused structures give an extra degree of freedom in defining the internal volume of the capsule, without comprising the surface particle integrity. Furthermore, the encapsulated particle may behave as a malleable membrane, which may allow external manipulation and/or reshaping of its topological profile.

Another example of a droplet within a droplet is illustrated in FIG. 12D. In this example, there are several inner fluidic gas droplets, each encapsulated by colloidal polystyrene particles, contained within a larger fluidic droplet. The larger fluidic droplet is also encapsulated with polystyrene particles.

FIG. 13 illustrates a gaseous droplet that is encapsulated with polymethylmethacrylate colloidal particles, produced using certain systems and techniques of the invention. In this example, the polymethylmethacrylate particles are about 1 micron in diameter.

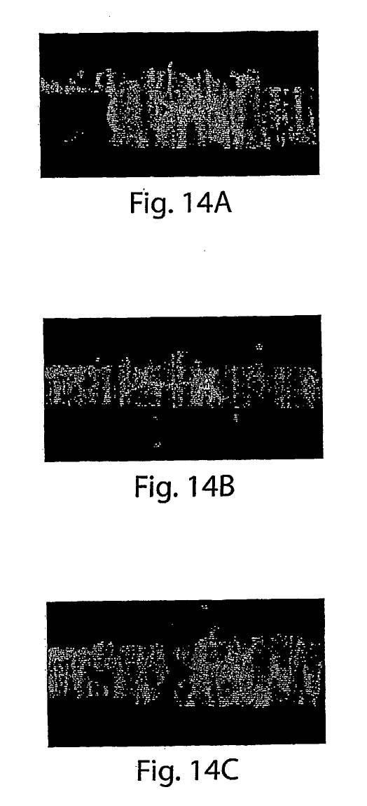

FIGS. 14A-14C illustrates the protection of the fluidic droplets against sheer induced coalescence. In these photomicrographs, fluidic droplets encapsulated within particles (FIG. 14A) are squeezed together between two glass plates. Despite extensive compression of the fluidic droplets between the parallel plates (FIG. 14B), the fluid droplets are able to maintain their individual identity after such compression (FIG. 14C). In these figures, the fluidic droplets are composed of gas, encapsulated within a shell of 2.0 micron polystyrene particles.

### EXAMPLE 6

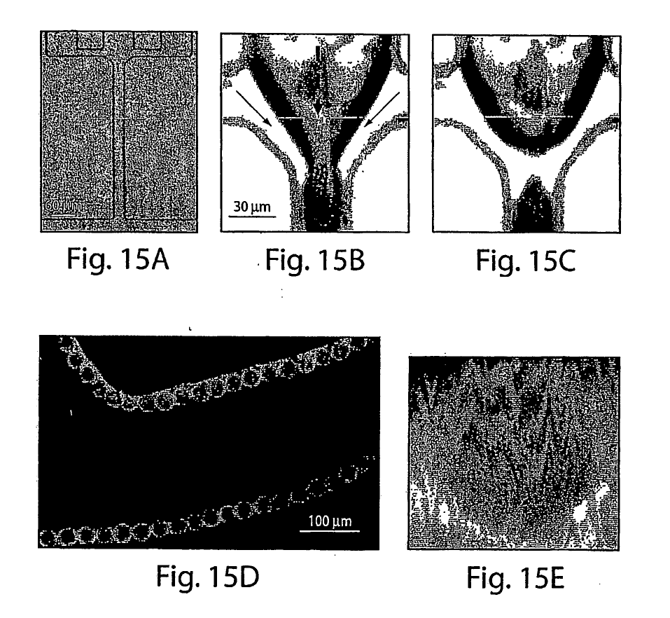

In this example, a three-channel hydrodynamic focusing device was designed in order to control particle delivery and assembly at the scale of individual shells (FIG. 15A). A suspension of colloidal particles was driven through the outer channels, while the inner channel carried the dispersed phase (gas or liquid). The interface between the continuous and dispersed phases served as the substrate for crystal assembly. In the example shown in FIGS. 15B and 15C, 4 micron diameter charge-stabilized fluorescent polystyrene beads (the large size was chosen to facilitate visualization) assembled as a monolayer on a gas thread, which eventually became unstable, and broke to form a spherical shell.

The curved interface was held stationary relative to the motion of the particles in the continuous phase, to allow sufficient time for the particles to adsorb and produce a close-packed structure. Typically, for a particle concentration of 0.1 volume percent, it was found that the encapsulated droplets were ejected at a rate of 10 per second. Higher formation frequencies were obtained by using a more concentrated suspension and tuning the driving pressures of the two phases. The shear-driven ejection of the jammed shells made the geometry of the outlet channel the main determinant of the size of the encapsulated droplet, and the continuous one-step assembly process produced monodisperse encapsulated gas droplets (FIG. 15D). A close-up of the encapsulated gas droplets revealed the tightly-packed jammed structure of the colloidal shell (FIG. 15E), a feature which conferred intrinsic stability.

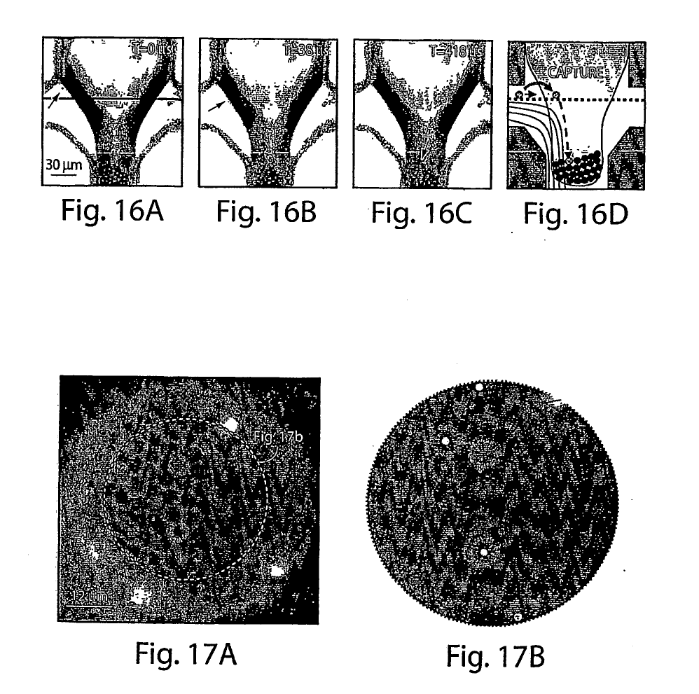

FIG. 15A is a photomicrograph of the flow-focusing device used in these experiments. Fluids were driven through the channels by connecting custom syringes to a supply of compressed air. The dispersed phase was injected through the inner channel, while the particle containing continuous phase was injected through the outer channels. A 1 mm×1 mm view chamber was constructed at the end of the device. In FIG. 15B, the direction of dispersed phase flow is indicated by a dashed arrow, while the direction of the colloidal suspension flow is indicated by the solid arrows. The flow of the continuous phase liquid focused the dispersed phase fluid into a narrow thread and targeted the particles onto the interface. The speed of the particles and the frequency of shedding could be controlled by tuning the difference in driving pressures of the inner and outer channels (example values are suspension: 1.92 psi, gas: 1.69 psi). The interfacial crystal, including 4 micron diameter charge-stabilized fluorescent polystyrene beads, grew and subsequently experienced greater shear, which resulted in the ejection of a “jammed” encapsulating shell (FIG. 16C). FIG. 15D shows monodisperse stable encapsulated bubbles arrayed along a gas/water interface in the view chamber. The apparent minor size differential was due to the differing heights of the shells from the focal plane of the objective. The droplets did not coalesce even when closely apposed and appeared to be stable indefinitely. FIG. 15E is a close-up of a single droplet shown in FIG. 15D. The Brownian particles (1.0 μm in diameter) appeared to be “jammed” in position.

It was observed that the shells were reproducibly shed at high particle velocities (10 cm/s), which suggested that each capture event (i.e. where a particle is adsorbed at the interface) occurred at a timescale of tens of microseconds. High-speed video at 70,000 frames per second was used to better understand the dynamics of the assembly. It was found that the colloidal particles had a well defined region of capture, characterized by the largest change in flow lines. The minima are indicated by the solid line in FIGS. 16A and 16D. Particles that approached the interface at or above this line were captured when they collide with the interface (FIG. 16B).

The particles appeared to be trapped on the interface in a deep potential energy well, estimated to be 10⁷ kT for micron diameter particles, and it was observed that the shear experienced by the particles from the surrounding fluid was insufficient to detach adsorbed particles. Instead the particles are transported by the flow to the anterior of the curved interface. Repeated capture and transport events resulted in a rapid build up of particles in a tightly packed structure, with the particles staking in parallel lines closely following the flow of the continuous phase (FIG. 16C).

FIG. 16 is a time-lapse sequence of the capture of an individual particle (particle indicated with a black arrow). In FIG. 16A, particles were captured when they approach the interface, at or above the indicated flow line. In FIG. 16B, the particle approaches the interface at a speed of 10 cm/s and adsorbs on the interface far from the other adsorbed particles. In FIG. 16C, the shear experienced by the particle from the flow, drove it to a stagnation point at the anterior of the curved interface. The particle movement was stopped by previously stacked particles. The particles stacked on the interface following the flow lines, with most of the particles arranged in a six-fold coordinated lattice. FIG. 16D is a schematic of the capture process. The particles that approached the interface above the solid line, underwent a large change in flow trajectory as the fluid entered the outlet channel, forcing the adsorption of the particle on the interface. The particles on flow lines below the solid line underwent smaller changes in trajectory, and did not appear to posses sufficient energy to overcome the barriers to adsorption.

The geometry of the focusing device appears to allow particle capture to occur far from the growing shell, which avoids steric and electrostatic repulsions a particle would otherwise experience if it directly approached a growing shell. This geometric advantage may allow the formation of more densely packed crystallites than possible through current methods of emulsion templating. Occasional missing particles along a stack can cause rearrangements through the tumbling of adjacent particles, which thus “self-heals” most defects in the interfacial packing. FIG. 17A shows a single encapsualted bubble revealing the well-ordered structure of the colloidal capsule. Triangulation of the particles, shown in FIG. 17B, reveals paired 5-7 defects in a six-fold coordinated lattice, which may be consistent with theoretical predictions of ground states of spherical crystals.

Without wishing to be bound by any theory, it is believed that, unlike thermally equilibrated spherical crystals, the energetically costly dislocations do not diffuse on the interface, thus revealing a freezing of the dynamics of the shell. Moreover, for colloidal capsules composed of Brownian particles, such as 1 micrometer polystyrene beads, thermal motion apparent in the bulk phase may be arrested in the tightly packed shell. This observation is in contrast with previously reported particle shells, where Brownian motion is often observed on the droplet interface. It has been postulated that jammed particulate systems undergo a universal liquid-to-solid transition characterized by a reduced set of parameters, i.e. applied stress or pressure, particle number density, and the energy of interactions in the system. In the unique case of particle-covered droplets (gas or liquid), surface tension may provide a two-dimensional isotropic compressive stress and the finite spherical topology of the droplet may result in unbounded confinement of the interfacially trapped particles. Such confinement may be required for a jamming transition of repulsive particles, such as for the charged stabilized colloids employed here (confinement is clearly not necessary for attractive particles).

Thus, it is believed that the high particle number densities obtained through this example of targeted delivery may result in the spontaneous jamming of the particles in the shell. Such jammed systems may undergo shear induced liquid-to-solid transitions, which can confer stability to the droplet: the jammed shell not only can resist spontaneous coalescence due to interfacial surface area minimization, it can also resist shear-induced coalescence. Based on many experiments with different materials for the continuous and dispersed phases and for the particles, this topologically induced jamming appears to be independent of the nature of the particle-particle interactions. The jammed capsule thus appears to be intrinsically stable, and spontaneous coalescence of the fully encapsulated droplets with each other or with an uncovered interface was not observed.

Visualization of the process of particle capture and assembly may allow the conclusion that specific input of energy may be required for the assembly of close-packed interfacial crystals. In the absence of flow, spontaneous adsorption of micron-size particles onto emulsion droplets to form particle shells was not observed. Addition of NaCl, up to a final concentration of 1.0 M, which reduces any particle/interface electrostatic repulsion, resulted in aggregation in the bulk of the suspension, but the aggregates did not adsorb and cover the droplets, within the timescale of a 10 minute experiment. Gentle agitation of the suspension was performed to prevent particle sedimentation, but coverage of the interface was still not achieved. More forceful agitation, however, produced partially covered droplets as observed for particle-stabilized emulsions. Thus, production of colloidal shells on fluid droplets may require specific input of energy through hydrodynamic flows to overcome barriers to adsorption. Indeed, the particles' non-dimensional Reynolds number in this device, Reₚ=Ua/v, was estimated to be 0.2, where U is the particle speed, a is the particle radius, and v is the kinematic viscosity of water, reflecting the non-negligible role of inertia on the capture events.

In these examples, the microfluidic device was manufactured using principles of soft-lithography introduced by Whitesides and coworkers. Surfactant-free fluorescent polystyrene particles (IDC Corporation) were diluted with purified water (Millipore) to a typical concentration of less than 0.1 volume percent. The particles were described as being hydrophobic with a small amount of surface charge providing colloidal stability in suspension. The colloidal suspension was filled in a gas tight syringe (Hamilton) and connected to a compressed gas tank through custom adapters. Polyethylene tubes were connected from the syringe to the continuous phase inlet hole of the device. A similar syringe without the suspension was connected to the dispersed phase inlet hole of the device. Pressure applied to the suspension in the syringe was independently controlled by a regulator (Bellofram) with a precision of 0.001 psi. It was found that driving the fluids using an applied pressure allowed more rapid control over the flow velocities than traditional flow-rate controlled syringe pumps.

To ensure reproducible production of fully encapsulated objects, the experiments were conducted in a pressure regime where the difference of driving pressures between the dispersed and continuous phase was small, on the order of 0.2-0.5 psi. For larger differences in driving pressures, incomplete coverage of the gas bubbles was observed, and the gas bubbles were unstable to coalescence in the view chamber. The dispersed phase used was varied. Droplets were produced with gaseous argon, CO₂, O₂, N₂, and liquid mineral oil (Sigma) and octanol (Sigma). The colloidal particles were also varied. The particles included monodisperse polystyrene particles of 1.6 μm, 2.1 μm, 4.0 μm, and 4.6 μm diameter, 1.6 μm diameter silica particles (Bangs Lab), 1.0 μm diameter PMMA particles (Bangs Lab), and polydisperse agglomerated gold microparticles, with mean diameters ranging from 1.0-3.99 μm (Sigma). All the particles were diluted with ultrapure water to typical concentrations of 0.1 volume percent.

### EXAMPLE 7

The example shows the wide range of encapsulated objects produced without surface modification of the colloidal particles. Typically, hydrophilic particles such as silica spheres suspended in water are chemically modified to increase hydrophobicity before adsorption is observed at the air/water interface or at the interface of oil droplets. Such surface modification may restrict particle/core combinations to intermediate wetting and, moreover, can reduce the efficiency of synthesis, since the hydrophobic particles flocculate rapidly in the bulk aqueous phase. An alternative means of stabilizing particles at the interface is to increase the dimensions of the particle. It is to be expected that the energetic barrier to adsorption increases with increased total charge, i.e. larger particles (assuming constant surface charge density). This increased energetic cost of forcing micron-size particles onto an interface, however, can be provided by the targeted hydrodynamic flows, as discussed in this example.

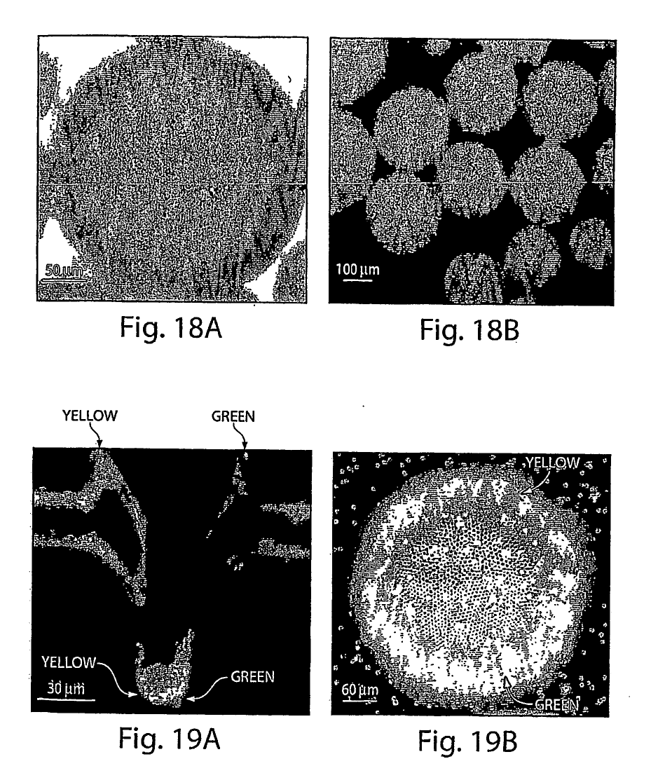

For example, air and oil droplets encapsulated with unmodified silica particles initially dispersed in water have been manufactured using these techniques (FIG. 18A). FIG. 18A shows unmodified silica particles on a mineral oil droplet. This is an example of colloidal armor composed of hydrophilic particles from a hydrophilic continuous phase adsorbed on a hydrophobic droplet. Thus, shells composed of micron-size hydrophilic silica and gold particles may be as stable as those produced from hydrophobic polystyrene, and similar arrest of Brownian motion in the jammed shells was observed. Thus, shell/core combinations, such as a fully hydrophobic shell around a hydrophilic core and vice versa, were produced. Capsules with unmodified conductive metallic particles have also been produced (FIG. 18B). This figure shows polydisperse gold particles on gas bubbles dispersed in water. This is an example of conductive armor on a gas bubble. The polydispersity of the particles employed resulted in a slight dispersion in the size of the jammed shells produced.

Capsules with various dielectric properties were obtained by varying the conductivity of the particles or the ratio of conductive and insulating particles on the interface. In the case of a fully conductive capsule, the fluid core can then be protected from stray electromagnetic fields (analogous to a Faraday cage). An appreciation of the fundamental energetic principles of interfacial assembly allows the production of new kinds of shells, with precise combinations and relative positions of particles on the interface. For instance, by loading particles differentially labeled with rhodamine and fluorescein in the two outer channels of the microfluidic device, hemi-shells, or Janus capsules, could be produced (FIG. 19). The ability to assemble two or more types of particles on a single shell may be useful in the production of chemically patterned shells that may be useful for targeting or sorting purposes.

FIG. 19A illustrates the assembly of particles on an air/water interface to produce Janus crystals. The yellow particles are 4.9 micron diameter polystyrene particles dyed with rhodamine, while the green particles are 4.0 micron particles dyed with fluorescein. FIG. 19B is an example of a Janus shell with approximately two hemispheres of different size particles and fluorescence.

### EXAMPLE 8

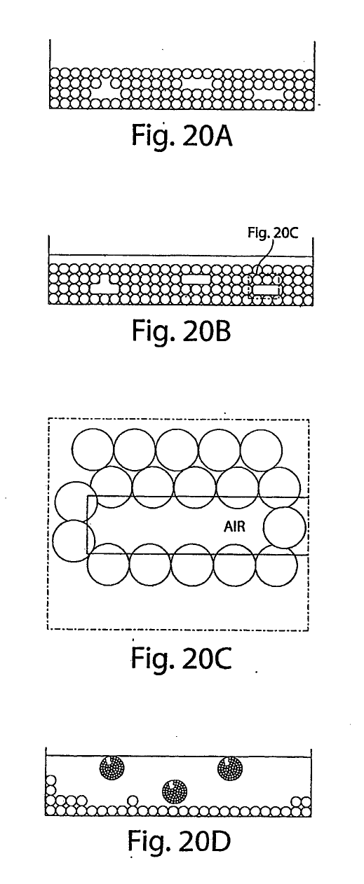

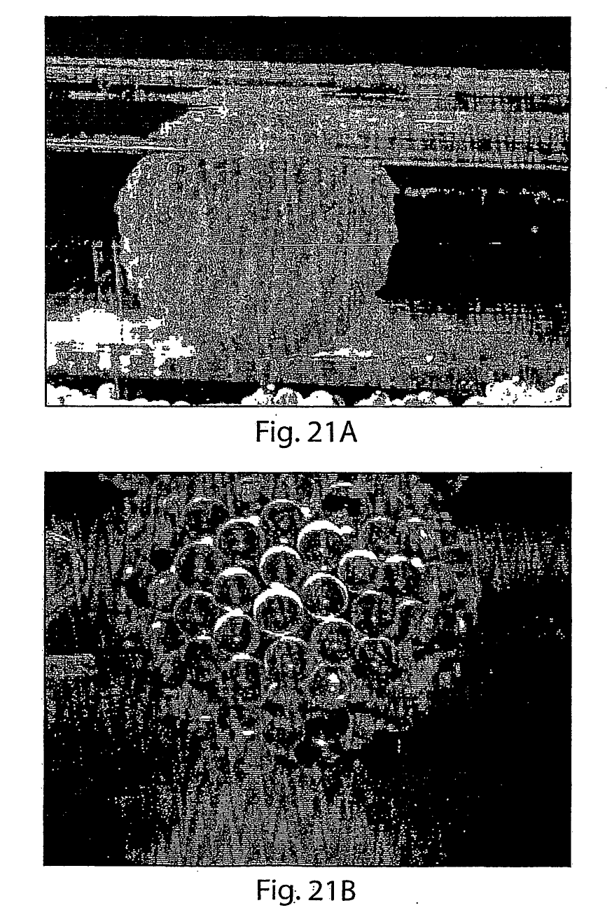

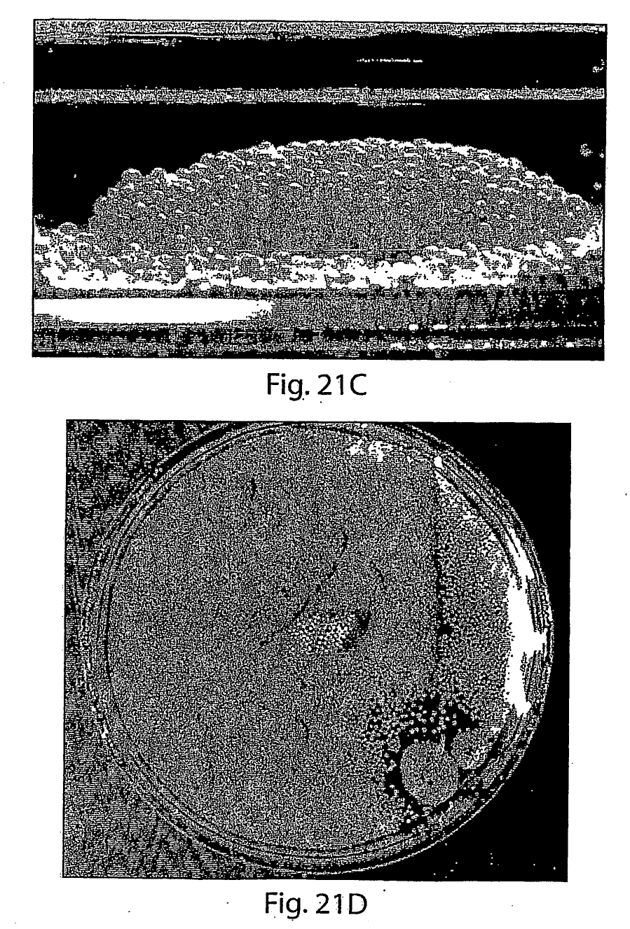

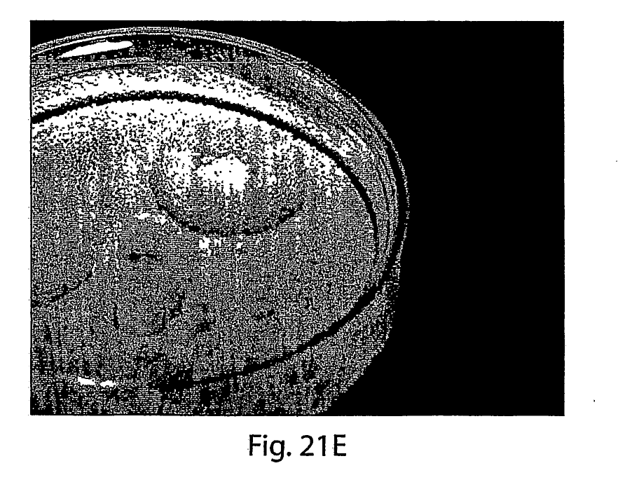

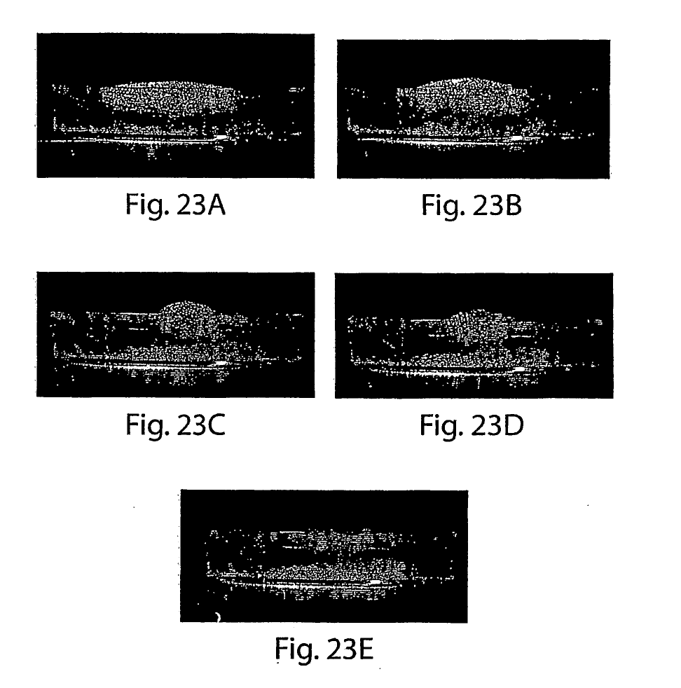

In this example, bubbles covered with hydrophilic particles greater than 50 microns in diameter were prepared through an air pocket trapping technique disclosed here (FIG. 20). Ground ZrO particles, size range 50 microns to 700 microns were poured into a petri dish to form a thin layer of porous media. Polystyrene particles, iron oxide aggregates, and agglomerated gold were also used to produce large coated bubbles using this technique. A liquid, preferably water was quickly added to the particle layer to ensure entrapment of air between the particles. The water penetrated the porous media until further infiltration is halted when the capillary pressure of the advancing water interface is balanced by the pressure of the trapped air. To make bubbles with gases other than air, the Petri dish can be placed in a suitable atmosphere, i.e. in a chamber with argon gas, if argon bubbles are to be trapped. In this way, a monolayer of particles is trapped at the air/water interface, and the untrapped particles can be brushed away mechanically, either by shaking the suspension or with a spatula. It is believed that the particles exhibit a finite contact angle due to contact angle hysterisis. The coated object can then be shaped mechanically, either by shaking or with a spatula to produce spherical and non-spherical coated bubbles, shown further herein. The composite material produced through the combination of the solid particles and the elastic air/water interface exhibits extensive plasticity which allows the bubbles to be shaped into spherical, non-spherical and topologically complex bubbles through mechanical means. Stable bubbles in excess of 1 mm in diameter were produced (FIGS. 21 and 23).

FIG. 20 illustrates a schematic of the synthesis process, not to scale. In FIG. 20A, granular particles were poured into a Petri dish to form a thin layer. The interstices of the particles were filled with gas from the atmosphere. FIG. 20B shows that a liquid, such as water, can be poured quickly to ensure trapping of the air in the granular media. A close-up of a trapped air pocket is shown in FIG. 20C. The liquid meniscus infiltrates the media until the capillary pressure of the liquid equals that of the trapped air. In FIG. 20D, the untrapped particles can be swept away mechanically, such as with a spatula, and the air bubble scooped up to produce stable large spherical and non-spherical particle covered bubbles.

Several photomicrographs if these fluidic droplets are shown in FIG. 21. FIG. 21A shows a spherical air bubble covered with 200 micron diameter ZrO particles. The bubble was about 4 mm in diameter. FIG. 21B shows a spherical air bubble covered with 500 micron diameter polystyrene particles. The bubble was about 4 mm in diameter. FIG. 21C is an air cylinder covered with 200 micron ZrO particles. The cylinder was prepared by mechanically shaping the trapped air in the granular media with a spatula. The axial length 1 cm, and the radius was 650 microns. In FIG. 21D, air cylinders and various non-spherical shapes covered with 200 micron ZrO particles are shown. The lengths of some of these bubbles are in excess of 2 cm.

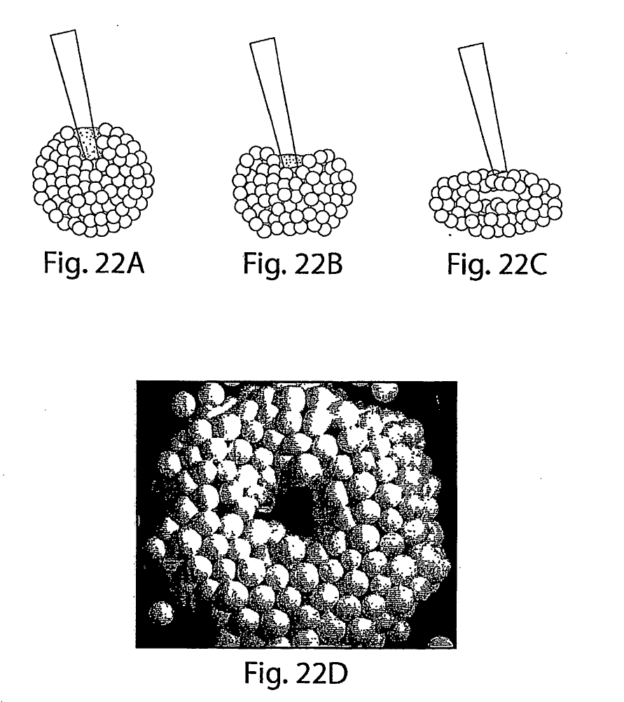

The particle coat stabilized the bubble against dissolution or coalescence, and reduces the buoyancy of the bubble, thus often preventing the bubble from rising past the bulk air/water interface and bursting. If light particles such as polystyrene is used, the top of the armored bubble may penetrate the bulk air/water interface, but the capillary interactions between the particles ensured continuous replacement of the thin fluid film between the particles, thus preventing bubble destabilization (FIG. 22A). In FIG. 22, shown schemtically, spherical ICM shells, when pierced with a pipette tip, may empty or buckle. The shell may collapse on itself and self heal to produce a topological hole. An photomicrograph of such a stable toroidal bubble covered with ZrO particles is shown in FIG. 22D.

The mechanical rigidity of the particle shell is not limited to spherical topologies. The bubble, when emptying due to the piercing of the pipette tip, buckles and falls inwards. The initially spherical bubble took on a discoid shape and eventually reached a point at which the shell collapsed at the entry point of the tip (FIG. 23). If the pipette tip is pulled out swiftly enough, the buckled shell can self heal the hole by fusing with the bottom half of the interface, producing a torus. The torus is topologically distinct from a sphere. The different radii of curvature of a toroidal bubble ensured that this configuration is not stable for bubbles and drops in static equilibrium. For instance, FIG. 21E shows a large particle covered toroidal bubble (diameter of 2 cm). A spatula was used to shape the air trapped in the granular monolayer to produce a torus. Thus, the jamming of colloidal particles on fluid interfaces appeared to be general to closed topologies, regardless of genus. Nevertheless, the particles can be destabilized from the interface by adding an appropriate amount of surfactant (FIG. 23). Despite penetrating the bulk air/water interface, the large spherocylinder covered with 500 micron polystyrene spheres shown in FIG. 23A remained stable for at least 2 hours. In FIG. 23B, after exposure to surfactant, the bubble lost particles and returned to a spherical shape (FIG. 23C). FIG. 23D shows the continuous adsorption of surfactant denuded the bubble of particles, and FIG. 23E shows that the exposed air/water interface destabilized and the bubble burst.

### EXAMPLE 9

This example illustrates that surfactants appeared to generally destabilize particle-covered bubbles and triggered their dissolution in a concentration-dependent manner. This observation was surprising and unexpected since surfactants are used widely in the flotation industry to induce adsorption of particles onto air bubbles, and are generally considered a stabilizing influence in dispersed states.

In these experiments, monodisperse particle-covered bubbles (armored bubbles) were synthesized using either a microfluidic hydrodynamic focusing method, or by simply shaking an aqueous suspension of particles to obtain polydisperse bubbles (see below). These quantitative experiments were performed with a model suspension of 4.0 micrometer diameter surfactant-free charge-stabilized polystyrene particles and the non-ionic surfactant Triton-X 100. Additionally, qualitative experiments with a wide variety of particles, such as gold, PMMA, and silica were conducted to obtain a general overview of the surfactant destabilization phenomenon.

Monodispersed charged-stabilized polystyrene latex particles of diameter 4.0 micrometers, 1.6 micrometer diameter silica particles (Bangs Lab), 1.0 micrometer diameter PMMA particles (Bangs Lab), and polydisperse agglomerated gold microparticles with mean diameters ranging from 1.0 to 3.99 micrometers (Sigma) were used in these experiments. The surfactants used were Triton-X 100, sodium dodecyl sulfate (SDS), Tween 20, cetyl triammonium bromide (CTAB), octyl-B-6-glucopyranoside, and Brij 35, all purchased from Sigma. The CMC of Triton-X100 ranged from 0.22-0.5 mM (data from manufacturer). The surfactant solutions were prepared with ultrapure water (Milipore) at concentration ranging from 0.1 to 10 times the CMC.

10 ml of an aqueous suspension of particles at a volume fraction of 0.1 was shaken manually and vigorously, for about 10 s in a 50 ml test tube. The result was a dilute suspension of gas bubbles, each coated with a jammed shell of particles.

2.5 microliters of the bubble solution was deposited onto a glass slide. 100 microliters of particle-free surfactant solution was deposited near the 2.5 microliters sample solution. The large difference in volumes was chosen to obtain a homogenous concentration of surfactant in the entire sample.

The size of the bubbles were followed by capturing pictures with a high-resolution camera. The bubbles were observed using a phase-contrast objective which enhances the contrast of the ejected particles. The bubble diameters were measured within an error of ±1 micrometers.

At least three bubbles were followed, and the experiment was repeated four times for each concentration of surfactant tested. Care was taken to ensure that each system only contained a small number of armored bubbles. Furthermore, the bubble of interest was always isolated from other bubbles by more than two times the bubble diameter in order to avoid multi-body effects. Since the system was exposed to the atmosphere, the concentration of air dissolved in the bulk around each bubble was rapidly equilibrated with atmospheric pressure. All experiments were carried out at room temperature.

In these experiments, a surfactant-free aqueous sample containing armored bubbles was placed onto a glass slide, and visualized from below using an inverted microscope. It was observed that the buoyant armored bubbles rose to the top of the droplet (FIG. 24A, which is a schematic of the experimental setup). Interestingly, the shell of particles appeared to deform at the bulk air-water interface to produce a generally flat facet (FIGS. 24B and 24C). FIG. 24B schematically shows that the buoyant bubbles rose to the surface of the drop and deform to form a facet at the interface, while FIG. 24C is a top view of the armored bubbles taken with an upright microscope. The particles composing the facet are in fact bridging the two air phases, that in the bubble and that in the atmosphere with an intervening film of water. The scale bar in FIG. 24C is 16 micrometers.

These observations suggest that the particles formed a bridge between the air phase in the bubble and the atmosphere, with only a thin layer of water in between. The bridging effect may be particularly important since it may allow for the rapid diffusion of gas out of the bubble directly into the atmosphere through the thin water film. The quantitative data for the lifetime of the bubbles appeared to be below theoretical predictions of the lifetime of similar-sized bubbles freely suspended in bulk water.

Viewed through the water phase (i.e. with the inverted microscope), it was observed that the bubble progressively took a “buckled” or non-spherical shape by losing some gas, after which the non-spherical bubble then remained stable without further changes in volume or shape for at least two days (FIG. 24D, scale bar is 48 micrometers).

The observation of buckling and the stable non-spherical shapes suggested that the interface of the armored bubble behaved in a solid-like manner, since equilibrium of non-spherical shapes of ordinary bubbles with an isotropic surface tension are generally prohibited. The ability to sustain non-spherical shapes, as shown here, is a hallmark of solid-like behavior. This solid-like behavior was recently proposed to arise from the “jamming” of the particles on the bubble interface and may be contrasted with the apparent maintenance of sphericity in other experiments, e.g., as previously described. The experiments using surfactant, described in the below examples, were performed after the bubble had reached this stable plateau, where it appeared to have an excess area for the volume enclosed, e.g. as compared to a spherical bubble.

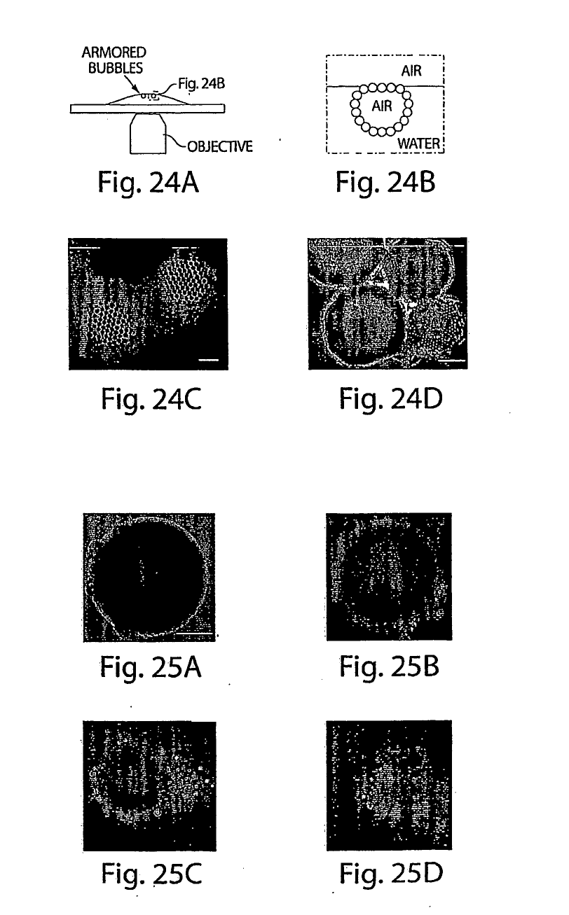

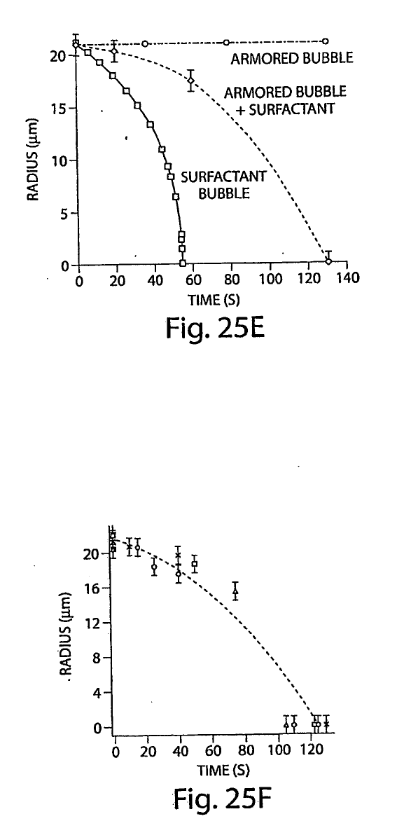

When a solution of Triton-X 100 at a concentration of 0.66 mM (i.e., above its critical micellar concentration, CMC) was added to the sample, the non-spherical bubble quickly regained a spherical shape (within one camera frame, or about 1 second) by ejecting excess particles from the interface (FIG. 25A). The armored bubbles in these experiments were covered with polystyrene particles. The spherical armored bubble subsequently proceeded to dissolve continuously and generally decrease in size until it disappeared (FIGS. 25A-25D, scale bar of 24 micrometers). This observation was reproducible and generally, an armored bubble with an initial radius of about 20 micrometers took 100±3 s to dissolve. This may be contrasted with the apparent infinite lifetime of a buckled bubble in an air saturated solution, and the comparatively shorter lifetime of 50 s for a simple surfactant-covered bubble. This is shown in FIG. 25E as a comparison of radius versus time for a stable armored bubble, an armored bubble exposed to surfactant, and a surfactant-covered bubble under the same experimental conditions. Note that in the presence of surfactant, the particles did not appear to halt dissolution, but slowed it down relative to that of a bare surfactant-covered bubble. FIG. 25F is a plot of radius versus time of four bubbles exposed to 0.66 mM Triton-X 100 showing the distribution of the time of dissolution of the bubbles, illustrating the reproducibility of the armored bubbles exposed to Triton-X 100 at a concentration of 0.66 mM.

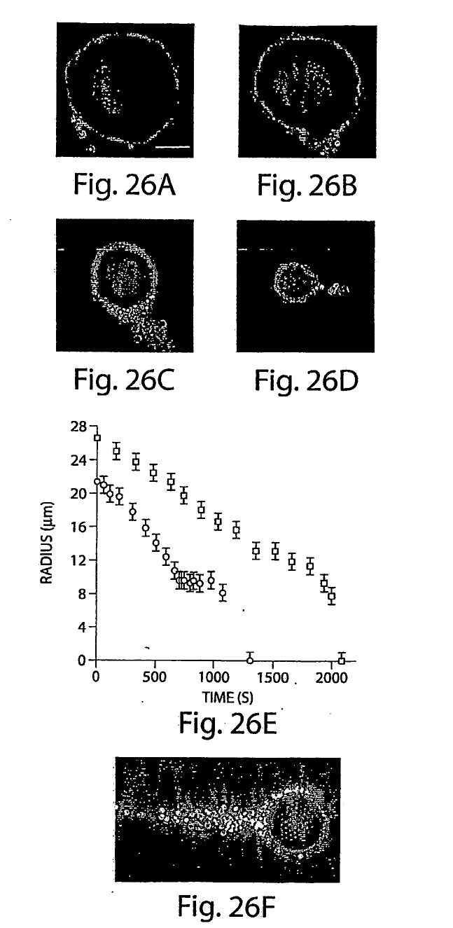

When Triton-X 100 was added at a concentration below its CMC (about 0.066 mM), different behavior was observed. The bubble appears to maintain its non-spherical shape throughout, but started to eject particles (bright white circles) while losing volume (FIGS. 26A-26D, scale bar of 24 micrometers). The bubble continued to lose gas in a generally discontinuous manner, with periods of transient stability when the bubble did not change in apparent radius (the apparent radius was taken to be one half the diagonal length of the smallest bounding rectangle). Moreover, unlike the case for exposure to surfactant at a concentration above the CMC, the rate of dissolution for individual bubbles was highly variable, ranging from 1190 seconds to 1341 seconds for bubbles with an initial radius of 20 micrometers, and appeared to be dependent on bubble history. This is shown in FIG. 26E as a comparison of apparent radius (half the diagonal length of the smallest bounding rectangle) versus time of two different armored bubbles exposed to the same experimental conditions. Note that these bubbles took much longer to dissolve (as compared to those shown in FIG. 25), ejected particles discontinuously, and exhibited points of stability where the apparent radius did not appear to change. There was also significant variability in the dissolution time of individual bubbles under similar experimental conditions.

However, despite the differences in response of individual bubbles, all of the bubbles eventually dissolved completely. The surfactant-induced destabilization seems to be general, and occurred for the various classes of surfactants and particles used. For instance, in FIG. 28, the armored bubbles were exposed to the anionic surfactant, sodium dodecyl sulfate, at 3 times its critical micellar concentration to determine the effect of surfactant type on the destabilization process. The process of destabilization was found to be very similar to the one described for Triton X-100 (FIG. 25E). In FIGS. 28A and 28B, the initially non-spherical bubble quickly returned to sphericity by losing particles and shrank continuously while ejecting particles, a behavior reminiscent of the non-ionic surfactants. However, in FIGS. 28C and 28D, unlike exposure to non-ionic surfactants, the particles ejected from the bubble were not colloidally stable, i.e. they are aggregated to each other and often remained associated with the armor shell. The aggregation may simply be due to the ions screening the charges on the particles. Despite the difference in appearance, there was no appreciable variation in the bubble lifetime when compared to that obtained after exposure to Triton-X 100 at a concentration above its CMC, as is shown in FIG. 28E. Scale bar in FIG. 28 is 40 micrometers.

To further understand the destabilization process, the bubbles were placed in an isolation chamber to study the particle-scale behavior of the shell. In the absence of surfactant, the shell was close-packed and all the (otherwise Brownian) particles were immobile or jammed, e.g., as discussed in previous examples. For the experiments employing surfactant concentrations above the CMC, it was found that the arrival of surfactant triggered an unjamming of the particulate shell, with the particles resuming Brownian motion in a well-defined hexagonal crystalline lattice. This unjamming of the shell appeared to destroy the solid-like behavior of the bubble, and the bubble regained a spherical shape.

Although these pictures appear to suggest that the particles are still on the interface (e.g., FIG. 25A), it is believed that the surfactant acts as a detergent, which washes the particle off the bubble interface by changing its wetting properties. It is well known that surfactants such as Triton-X 100 promote the wetting of hydrophobic surfaces such as polystyrene, by adsorbing on the surface, to produce a hydrophilic layer. Unfortunately, the low initial contact angle of surfactant-free charge stabilized polystyrene particles on the interface, 40 degrees (obtained through cryo-SEM imaging), prevented visual confirmation of changes in contact angle due to changes in wetting properties. Yet other evidence suggested that the particles no longer straddled the interface: armored bubbles exposed to surfactants appeared to be completely denuded of particles when they are exposed to shear rates of 4 s⁻¹ in simple shear flow, while the particles on jammed shells which were not exposed to surfactants remained trapped on the interface at similar shear rates.

It is thus believed that some weak, as of yet unexplained attractive force maintained the particles close to the interface, which gives rise to the observed well-ordered thermally equilibrated shell. It follows that since the particles did not form a jammed network that straddles the interface, the shell was unable to resist the dissolution of the bubble and the particles came off rather easily as the bubble disappeared.

The behavior of the bubble when exposed to surfactant concentrations below its CMC appeared to be more intricate. It is apparent that some solid-like characteristic was retained by the interface, since non-spherical shapes could still be supported (FIG. 26A-26D) and the shell exhibited some resistance, albeit weakly, to dissolution (FIG. 26E). In FIG. 26F, one such bubble, when exposed to surfactant, dissolved, leaving a comet-like trail of colloidal particles.

Moreover, viewing of the particle-scale behavior of the shell revealed that the particles did not resume Brownian motion, and the shell remained jammed, which suggested that the particles were still adsorbed on the interface. Thus, destabilization for concentrations below the CMC requires a mechanical explanation in addition to the chemical explanation given above. It is believed that the mechanical trigger was the stresses built up in the shell by the surface tension-induced compression, which when large enough, forced the particles out of the interface. As shown below, this appeared to account for the observation of the discontinuous ejection of the particles as the bubble dissolves.

Initially, the particle shell appears to provide active rather than passive resistance to the dissolution of the bubble. To illustrate the distinction, consider a balloon composed of a thin elastic membrane: inflating the balloon causes the buildup of tensions in the membrane which must resist the internal pressure of the trapped air. Thus, a blown up spherical balloon is under higher stress than a deflated one. In contrast, in the case of armored bubbles, the deflation of the bubble due to the dissolution process may increase the stresses on the shell, and it would thus appear that the state of spherical close-packing would be the point of lowest stress.

Subsequent removal of volume to produce the stable non-spherical shapes observed thus increases the stress in the shell. This observation can be rationalized by assuming that the hardcore repulsion of the particles prevents compressive deformation, which must happen when the particles are trapped in the shell. The addition of surfactant “untraps” the system, and highly stressed particles could then be ejected to relieve the stress buildup. The stress reduction appeared to be rapid and complete in the case of high surfactant concentrations, since the particles were washed off completely from the bubble interface. In contrast, for low surfactant concentrations, some anisotropic stresses could build up before failure through ejection was observed.

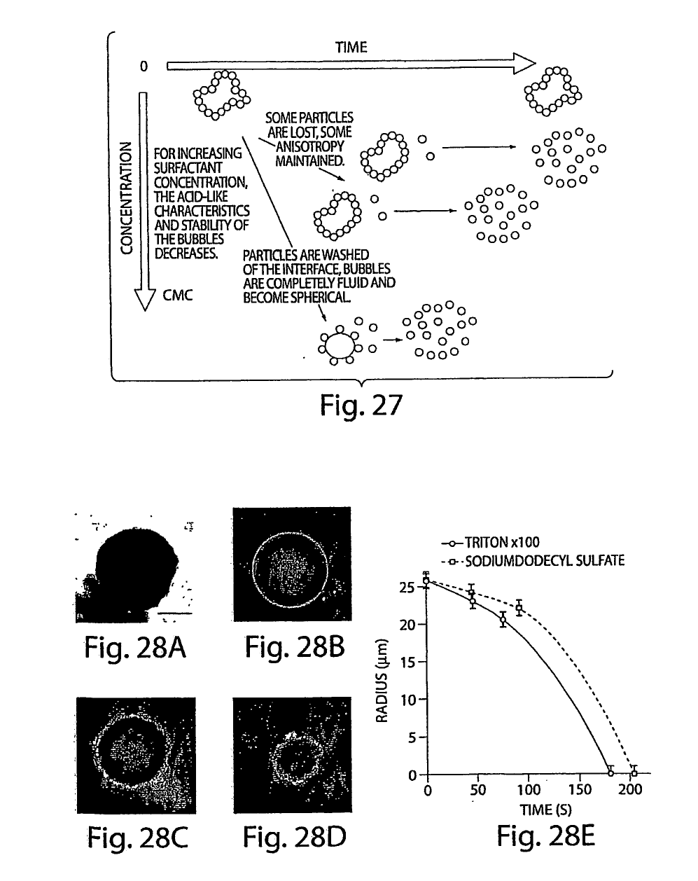

Some of these concepts are schematically illustrated in FIG. 27, which is a phase diagram of the armored bubbles' response to surfactant. Increasing surfactant concentration reduced the solid-like characteristics of the bubble and its lifetime. For surfactant concentrations at the CMC and above, the particles were washed off the bubble interface and the bubble became more fluid-like. The longer dissolution time of these fluid-like armored bubbles, relative to simple surfactant-covered bubbles, may be due to the shielding of the bubble surface by the gas impermeable particles.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising acts of:
providing a fluidic droplet and a plurality of particles; and
directing hydrodynamic energy to the plurality of particles to cause the particles to form a particle shell surrounding at least a portion of the fluidic droplet.

2. The method of claim 1, wherein the fluidic droplet is a liquid.

3. The method of claim 1, wherein the fluidic droplet is gaseous.

4. A method, comprising acts of:
providing a first fluid;
providing a second fluid containing discrete particles;
bringing the second fluid into contact with the first fluid; and
forming a fluidic droplet, comprising the first fluid, within the second fluid, wherein the fluidic droplet is encapsulated with at least some of the discrete particles through action of the second fluid.

5. The method of claim 4, wherein the method is performed using a microfluidic device.

6. The method of claim 5, wherein the microfluidic device comprises a hydrodynamic focusing apparatus.

7. The method of claim 4, wherein the first fluid is a liquid.

8. The method of claim 7, wherein the liquid is an oil.

9. The method of claim 4, wherein the first fluid is gaseous.

10. The method of claim 4, wherein the first fluid is air.

11. The method of claim 4, wherein at least some of the particles are colloidal.

12. The method of claim 4, wherein at least some of the particles are polymeric.

13. The method of claim 4, wherein at least some of the particles comprise polystyrene.

14. The method of claim 4, wherein at least some of the particles comprise silica.

15. The method of claim 4, wherein at least some of the particles comprise gold.

16. The method of claim 4, wherein at least some of the particles have a maximum dimension of less than about 10 microns.

17. The method of claim 4, wherein the second fluid comprises water.

18. A method, comprising acts of:
providing a fluidic droplet able to retain a shape when left undisturbed that is not achievable by an undisturbed fluidic droplet free of discrete particles; and
causing the fluidic droplet to form a shape achievable by an undisturbed fluidic droplet free of discrete particles.

19. The method of claim 18, wherein the fluidic droplet is encapsulated with discrete particles.

20. The method of claim 18, wherein the act of causing the fluidic droplet to form a shape comprises exposing the fluidic droplet to a surfactant.

21. The method of claim 18, wherein the fluidic droplet is a liquid.

22. The method of claim 21, wherein the liquid is an oil.

23. The method of claim 18, wherein the fluidic droplet is gaseous.

24. A method, comprising an act of:
shaping a layer of discrete particles disposed between a gas and a liquid to produce one or more fluidic droplets encapsulated with the particles.

25. A method, comprising an act of:
growing a fluidic droplet encapsulated with discrete particles by directing individual particles to a fluid-fluid interface.

26. An article, comprising:
a fluidic droplet, encapsulated with discrete particles, able to retain a shape when left undisturbed that is not achievable by an undisturbed fluidic droplet free of discrete particles.

27. The article of claim 26, wherein the fluidic droplet is non-spherical.

28. The article of claim 26, wherein the shape is cylindrical.

29. The article of claim 26, wherein the shape is toroidal.

30. The article of claim 26, wherein the fluidic droplet is elongate.

31. The article of claim 26, wherein the fluidic droplet encapsulated with discrete particles is in physical contact with a second fluidic droplet encapsulated with discrete particles.

32. The article of claim 31, wherein the fluidic droplet and the second fluidic droplet do not coalesce.
